(19) United States
(12) Patent Application Publication
(10) Pub. No.: US 2026/0101340 A1
(43) Pub. Date: Apr. 9, 2026

(54) METHODS FOR PRE-EMPTIVE BUFFER STATUS REPORTING FOR WIRELESS ACCESS BACKHAULING

(71) Applicant: Samsung Electronics Co., Ltd., Suwon-si (KR)

(72) Inventors: Jonas SEDIN, Chertsey (GB); Milos TESANOVIC, Chertsey (GB)

(21) Appl. No.: 19/347,034

(22) Filed: Oct. 1, 2025

(30) Foreign Application Priority Data
Oct. 4, 2024 (GB) 2414625.0
Sep. 2, 2025 (GB) 2514496.5

(51) Int. Cl. H04W 72/20; H04W 24/10

(52) U.S. Cl. CPC H04W 72/20; H04W 24/10

(57) ABSTRACT

The disclosure relates to a 5th generation (5G) or 6th generation (6G) communication system for supporting a higher data transmission rate. A method performed by a wireless access backhaul (WAB) node in a wireless communication system is provided. The method includes identifying a condition at the WAB node, and in response to identifying the condition, transmitting, to a second network node over a backhaul connection, scheduling assistance information, wherein the condition is at least one of determining, based on a buffer status report (BSR) received from a first network node, that data will have to be transmitted over the backhaul connection, determining, based on identifying a procedure being performed, to be performed, or having been performed by at least one of the first network node, the WAB node or the second network node, that data will have to be transmitted by the WAB node over the backhaul connection, identifying that an uplink (UL) grant is provided to a user equipment (UE) in response to a BSR that indicates a logical channel not associated with a system resource block (SRB), identifying that a BSR is received from a UE and the BSR indicates a logical channel not associated with an SRB, identifying a trigger from the radio resource control (RRC) layer, or identifying that a message will be sent over at least one of the NGAP or Xn interfaces.

### CROSS-REFERENCE TO RELATED APPLICATION(S)

This application is based on and claims under 35 U.S.C. § 119(a) of a United Kingdom patent application number 2414625.0, filed on Oct. 4, 2024, in the United Kingdom Intellectual Property Office, and of a United Kingdom patent application number 2514496.5, filed on Sep. 2, 2025, in the United Kingdom Intellectual Property Office, the disclosure of each of which is incorporated by reference herein in its entirety.

### BACKGROUND

### 1. Field

The disclosure relates to a method relating to pre-emptive buffer status report (BSR). More particularly, the disclosure relates to a method relating to pre-emptive BSR in a network incorporating wireless access backhaul (WAB), for example within 3^{rd} Generation Partnership Project (3GPP), 5th Generation (5G) New Radio (NR) and NR-based networks.

### 2. Description of the Related Art

5G mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method relating to pre-emptive buffer status report (BSR) in a network incorporating wireless access backhaul (WAB).

Additional aspects will be set forth in part in the description which follows and, in part, will be apparent from the description, or may be learned by practice of the presented embodiments.

In accordance with an aspect of the disclosure, a method performed by a wireless access backhaul (WAB) node in a wireless communication system is provided. The method includes identifying a condition at the WAB node, and in response to identifying the condition, transmitting, to a second network node over a backhaul connection, scheduling assistance information, wherein the condition is at least one of determining, based on a buffer status report (BSR) received from a first network node, that data will have to be transmitted over the backhaul connection, determining, based on identifying a procedure being performed, to be performed, or having been performed by at least one of the first network node, the WAB node or the second network node, that data will have to be transmitted by the WAB node over the backhaul connection, identifying that an uplink (UL) grant is provided to a user equipment (UE) in response to a BSR that indicates a logical channel not associated with a system resource block (SRB), identifying that a BSR is received from a UE and the BSR indicates a logical channel not associated with an SRB, identifying a trigger from the radio resource control (RRC) layer, or identifying that a message will be sent over at least one of the NGAP or Xn interfaces.

In accordance with another aspect of the disclosure, a wireless access backhaul (WAB) node in a wireless communication system is provided. The WAB node includes a transceiver, and at least one processor coupled to the transceiver, wherein the at least one processor is configured to identify a condition at the WAB node, and in response to the identifying of the condition, transmit, to a second network node over a backhaul connection, scheduling assistance information, wherein the condition is at least one of determining, based on a buffer status report (BSR) received from a first network node, that data will have to be transmitted over the backhaul connection, determining, based on identifying a procedure being performed, to be performed, or having been performed by at least one of the first network node, the WAB node or the second network node, that data will have to be transmitted by the WAB node over the backhaul connection, identifying that an uplink (UL) grant is provided to a user equipment (UE) in response to a BSR that indicates a logical channel not associated with a system resource block (SRB), identifying that a BSR is received from a UE and the BSR indicates a logical channel not associated with an SRB, identifying a trigger from the radio resource control (RRC) layer, or identifying that a message will be sent over at least one of the NGAP or Xn interfaces.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a WAB node and how it relates to UEs, a backhaul gNodeB (gNB), a backhaul 5G core (5GC), a neighboring gNBs and the 5GC of a UE according to an embodiment of the disclosure;

FIG. 2 illustrates a two-hop IAB network as described in 3GPP NR Rel-16 and further enhanced in Rel-17 according to an embodiment of the disclosure;

FIG. 3A illustrates an example of operation without pre-emptive BSR according to an embodiment of the disclosure;

FIG. 3B illustrates an example of triggering pre-emptive BSR based on uplink (UL) grant according to an embodiment of the disclosure;

FIG. 3C illustrates an example of triggering pre-emptive BSR based on receiving a BSR according to an embodiment of the disclosure;

FIG. 4 is a signal flow diagram illustrating a WAB node, pre-emptive BSR on a WAB backhaul in response to conditions at a relay node according to an embodiment of the disclosure;

FIG. 5A is a signal flow diagram illustrating a data that will have to be transmitted over user plane data is indicated to a WAB node according to an embodiment of the disclosure;

FIG. 5B is a signal flow diagram illustrating data that will not have to be transmitted over the control plane data is indicated to a WAB node according to an embodiment of the disclosure;

FIG. 6 is a signal flow diagram illustrating a method for pre-emptive BSR according to an embodiment of the disclosure;

FIG. 7 is a signal flow diagram illustrating an example of a relay node determining based on identifying a procedure being performed by a first network node or based on identifying a procedure to be performed by the first network node, that data will have to be transmitted over a backhaul connection according to an embodiment of the disclosure;

FIG. 8 is a signal flow diagram illustrating an example of pre-emptive scheduling assistance information during handover. The source WAB-gNB may predict that a handover will soon be performed according to an embodiment of the disclosure;

FIG. 9 is a signal flow diagram illustrating an example of pre-emptive scheduling assistance information triggered as WAB-MT is handed over according to an embodiment of the disclosure;

FIG. 10 illustrates an example method of a WAB node in a communication network according to an embodiment of the disclosure;

FIG. 11 illustrates an example method of a WAB node in a communication network according to an embodiment of the disclosure;

FIG. 12 is a block diagram of a network entity according to an embodiment of the disclosure;

FIG. 13 is a block diagram of a terminal or user equipment (UE) according to an embodiment of the disclosure;

FIG. 14 is a block diagram of a base station (BS) according to an embodiment of the disclosure; and

FIG. 15 is a block diagram of a network entity according to an embodiment of the disclosure.

The same reference numerals are used to represent the same elements throughout the drawings.

### DETAILED DESCRIPTION

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “^{˜}unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜,” “second ˜,” etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the present disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the present disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B,” such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

The following description of examples of the disclosure, with reference to the accompanying drawings, is provided to assist in a comprehensive understanding of the disclosure, as defined by the claims. The description includes various specific details to assist in that understanding but these are to be regarded as merely exemplary. Accordingly, those of ordinary skill in the art will recognize that various changes and modifications of the examples described herein can be made.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the disclosure.

The terms and words used herein are not limited to the bibliographical or standard meanings, but, are merely used to enable a clear and consistent understanding of the examples disclosed herein.

Throughout the description and claims, the words “comprise,” “contain” and “include,” and variations thereof, for example “comprising,” “containing” and “including,” means “including but not limited to,” and is not intended to (and does not) exclude other features, elements, components, integers, steps, processes, functions, characteristics, and the like.

Throughout the description and claims, the singular form, for example “a”, “an” and “the”, encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of an WAB node in the examples below may be applied to any other suitable type of entity performing functions of a network node, and in particular to any type of relay node.

The skilled person will appreciate that certain examples of the disclosure may not be directly related to standardization but rather proprietary implementation of some of the WAB functions or non-WAB related functions of NR Rel-17 and beyond networks.

The skilled person will appreciate that the disclosure is not limited to the specific examples disclosed herein. For example:
The techniques disclosed herein are not limited to 3GPP 5G.
The techniques disclosed herein are not limited to WAB or relay networks.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the disclosure may be provided in the form of a system (e.g. a network) comprising one or more such apparatuses/devices/network entities, and/or a method therefor. For example, in the following examples, a network may include one or more WAB or relay nodes.

It will be appreciated that examples of the disclosure may be realized in the form of hardware, software or a combination of hardware and software. Certain examples of the disclosure may provide a computer program comprising instructions or code which, when executed, implement a method, system and/or apparatus in accordance with any aspect, claim, example and/or embodiment disclosed herein. Certain embodiments of the disclosure provide a machine-readable storage storing such a program.

### Wireless Access Backhaul

Wireless access backhaul (WAB) is the name for a new type of node that is being introduced to 3GPP. The purpose of the WAB is to provide support for a base station, which acts as a relay, where the backhauling is provided over a wireless link, with less standard impacts compared to other solutions. For instance, the backhaul link performs backhauling of the interfaces from a gNB to the core network, i.e. the CP interface between gNB and Access and Mobility Management Function (AMF) and other nodes, as well as UP interface between gNB and UPF. This is as opposed to IAB, where the “relay” is only the gNB-DU and the backhauling link carries traffic via gNB-DU and gNB-CU. The WAB node is envisioned to be capable of mobility, to serve use cases such as 5G access onboard aircraft, cruise ships and other vehicles in remote areas. The WAB may also be deployed in emergency areas or during public safety cases.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

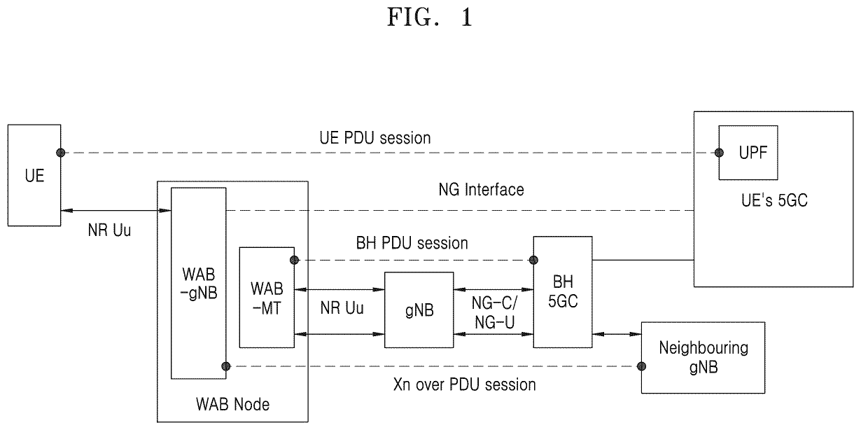

The WAB node may be seen in FIG. 1. FIG. 1 illustrates the WAB node and how it relates to UEs, the backhaul gNB, backhaul 5GC, neighboring gNBs and the 5GC of a UE according to an embodiment of the disclosure.

The 3GPP Rel-19 Study Item “Study on additional topological enhancements for NR” [RP-241264] had the following objectives related to WAB:
Study the support of WAB including [RAN3, RAN2]:
Study the architecture and protocol stack of supporting a gNB with MT function providing Packet Data Unit (PDU) session backhaul.
Study impact of WAB mobility within an existing RAN (e.g., inter-gNB neighbor relations).
Identify necessary inter-gNB- and gNB-to-CN signaling to address the support of WAB.
Study signaling enhancements on resource multiplexing for WAB.

NOTE 1: No impact on the UE.

NOTE 2: Coordination with other WGs (e.g. SA2) when needed.

The results of the study were captured in TR 38.799 “Study on topological enhancements for NR.”

The 3GPP Rel-19 Work Item “Additional topological enhancements for NR” [RP-242395] have the following objectives related to WAB:
Specifications for the support of WAB including [RAN3]:
Support of a WAB-node including a WAB-gNB and a WAB-MT.
Support of backhauling of the WAB-gNB's NG, Xn and OAM traffic over the WAB-MT's PDU session(s).
Support of Xn interface(s) by the WAB-gNB with the WAB-MTs serving Backhaul (BH) RAN node and with other surrounding gNBs, including how to avoid setting up Xn between WAB-gNBs.
Defining the behavior of WAB-node in case the authorization status of WAB-MT and/or WAB-gNB changes.
Network integration procedures for WAB nodes.
Handling of WAB-gNB's traffic (including Xn, NG and OAM traffic) during WAB-node mobility, including the case where the WAB-MT's BH PDU session changes.
Support the UE's AMF change for UEs connected to, or camped on, a WAB-gNB.
UE's ULI that reflect the WAB node's location.
The handling of:
PCI collision avoidance.
Reconfiguration of TAC and RANAC on WAB-gNBs.
Mechanisms to avoid multi-hop WAB topology.
Radio-resource coordination between access and backhaul links.
NG connection management.

### IAB

In 3rd Generation Partnership Project (3GPP) 5th Generation (5G) New Radio (NR), Integrated Access and Backhaul (IAB) is a technique for providing wireless backhaul as an alternative to a fiber backhaul network. An IAB network comprises IAB nodes, at which wireless resources are shared between wireless backhaul and access links. By means of such a configuration, it is possible to install nodes without the necessity of providing a fiber data connection, thereby allowing speedy and simple roll out of network coverage to locations where no such data connection is available or possible. Due to the limited coverage area of an IAB node, the backhaul network is typically implemented as a multi-hop network with backhaul traffic traversing multiple IAB nodes.

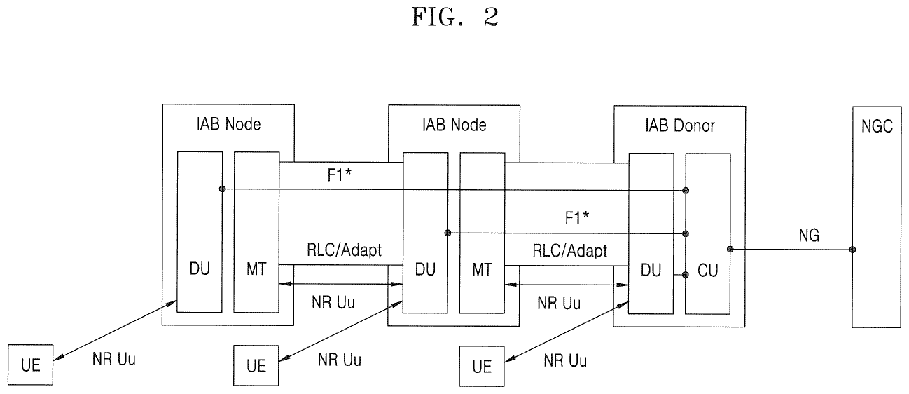

FIG. 2 (adapted from TR 38.874 “Study on Integrated Access and Backhaul,” V16.0.0, December 2018) shows a two-hop IAB network as described in 3GPP NR Rel-16 and further enhanced in Rel-17. 3GPP 5G Release 16 was the first release comprising the IAB feature according to an embodiment of the disclosure. Release 17 comprised enhancements on top of the Release 16 baseline and is now frozen. Work on Release 18 is currently underway to develop and improve features relating to IAB relative to previous Releases, most notably the mobility of IAB nodes. Assumption in previous Releases was that IAB nodes are stationary.

### BSR and Pre-Emptive BSR

In NR and LTE networks, in order to assist scheduling done by the base station/access point, the terminal (UE) provides feedback on the occupancy of its buffers—it reports the amount of data in the UE Uplink (UL) buffer available for transmission. This mechanism is known as Buffer Status Reporting, or BSR, and is a function of the MAC layer. BSR can be trigger-based or configured to be sent periodically and uses several different formats (3GPP TS 38.321). For purposes of BSR, radio bearers/logical channels (LCHs) are grouped into LCH groups, or Logical Channel Groups (LCGs). A BSR is typically encapsulated as a Medium Access Control (MAC) Control Element (CE).

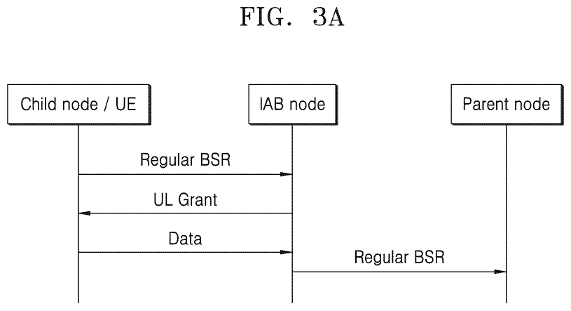

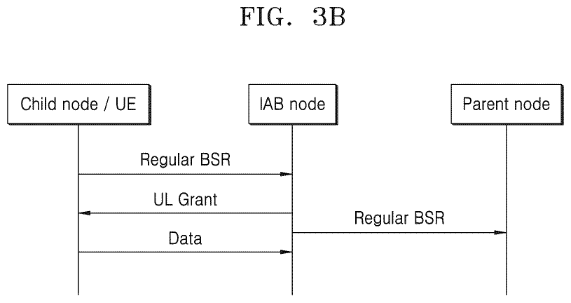

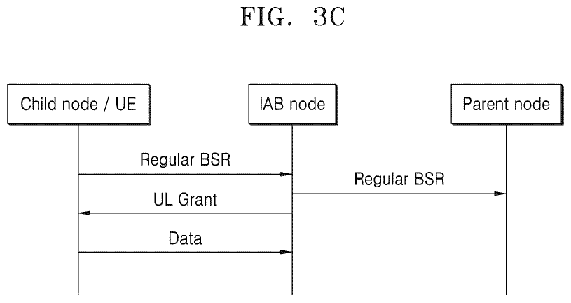

An IAB node features, at least conceptually, a base station part (or DU), and an MT part, as shown in the previous section. In a multi-hop network, latency delays from a node not being able to request resources until data is received from its child node (despite already having knowledge of incoming data e.g. via BSR received from child node), are likely to accumulate due to the number of hops and aggregated volume of data at IAB nodes. It may therefore be beneficial for the MT part of an IAB node to request uplink (UL) resources for the UL data transmission from its parent node even before it actually receives the data to be transmitted from its child node. This is why pre-emptive BSR was introduced into Rel-16 IAB, which can be seen in FIGS. 3A to 3C. FIG. 3A illustrates an example of operation without pre-emptive BSR according to an embodiment of the disclosure. FIG. 3B illustrates an example of triggering pre-emptive BSR based on UL grant according to an embodiment of the disclosure. FIG. 3C illustrates an example of triggering pre-emptive BSR based on receiving a BSR according to an embodiment of the disclosure. The BSR formats are identified by MAC sub headers with predefined LCID values, while a Pre-emptive BSR format is identified by a MAC sub header with a predefined eLCID value according to an embodiment of the disclosure.

The above information is presented as background information only to assist with an understanding of the disclosure. No determination has been made, and no assertion is made, as to whether any of the above might be applicable as prior art with regard to the disclosure.

Pre-emptive BSR was introduced for IAB nodes in order to increase scheduling efficiency by an IAB node pre-emptively sending a BSR if either the IAB node receives a BSR or SR from a UE or a child IAB node, or if the IAB node sends an UL grant to schedule a UE or a child node.

The pre-emptive BSR may be triggered for any type of uplink data that a UE or child node indicates in the uplink BSR. This is relevant for an IAB node, as the IAB node is only the DU of a gNB, which means that all data (user plane and much of control signaling including RRC) intended to a gNB needs to be forwarded from an IAB node to its parent CU via the backhaul network of IAB nodes.

Pre-emptive BSR may also be useful for a range of relay or repeater nodes, such as WAB. In WAB however, currently only a single hop is being discussed, which means that not necessarily all data that is sent to a WAB shall be forwarded on the backhaul link, since the WAB features a full gNB inside the WAB node. This means that some data sent by a UE may be terminated in the WAB node. This means that pre-emptive BSR may need to be adjusted to be useful for WAB as it does not apply to WAB in its current form, and the issue identified above (need to ensure that Pre-BSR only covers data which will eventually be forwarded) is a new issue identified by the inventors of the disclosure.

Aspects of the disclosure relate to methods for modifying the concept of scheduling latency reduction via pre-emptive BSR, by adapting pre-emptive BSR and related techniques to the WAB use-case. While this disclosure is described in terms of a WAB node, it may also apply to other types of repeaters or relays. For instance, it may apply to any type of 6G relay or repeater node.

In the description below, the description may apply to eNBs, gNBs, en-gNBs, NG-RANs or NG-eNB. For instance, in some cases the below description may be for an eNB, but it may also apply for NG-eNB (eNB is connected to EPC, while NG-eNB is connected to 5GC). In some cases below, there may also be methods explicitly for an NG-eNB, en-gNB, gNB, or NG-RAN.

In a first aspect of the disclosure any type of relay node may be configured to pre-emptively signal buffer status reports or other scheduling assistance information on the backhaul link in response to conditions at the node, where the conditions are related to specific received data from a UE or other node or predicting that data will have to be transmitted or forwarded over the backhaul link based on a procedure that the UE or another node is performing.

This can be configured by the gNB that is backhauling the node, i.e the backhaul gNB or the donor gNB, or it may a configuration that is available by default for a relay node.

The pre-emptively signaled buffer status or other scheduling assistance information may be sent over the backhauling link to the backhauling gNB by the—MT (the part that communicates with the backhauling gNB) part of the node.

In another aspect of the disclosure, the WAB node may be configured to pre-emptively signal buffer status reports or other scheduling assistance information on the WAB backhaul link in response to conditions at the WAB-gNB, where the conditions are related to specific received data from a UE or other node or predicting that data will have to be transmitted or forwarded over the backhaul link based on a procedure that the UE or another node is performing.

This can be configured by the gNB that is backhauling the WAB node, i.e the Backhaul gNB, or it may a configuration that is available by default for a WAB node.

The pre-emptively signaled buffer status or other scheduling assistance information may be sent over the backhauling link to the backhauling gNB by the WAB-MT.

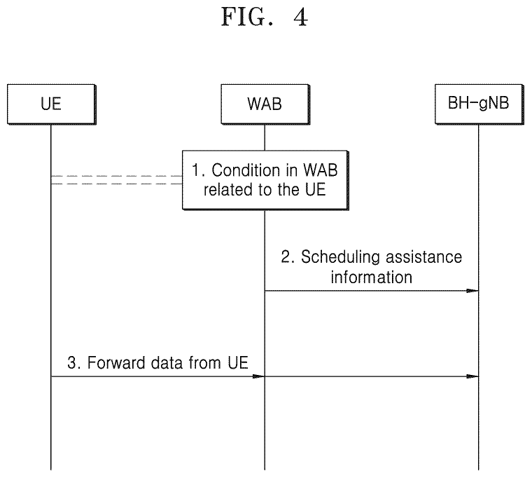

FIG. 4 illustrates an aspect in which a relay node (e.g. a WAB node) pre-emptively signals scheduling assistance information (e.g. pre-emptive BSR) on a backhaul connection (e.g. WAB backhaul) in response to conditions at the relay node according to an embodiment of the disclosure.

Referring to FIG. 4, in operation 1, the relay node (e.g. a WAB node) identifies a condition at the relay node. The condition may relate to a first network node (e.g. a UE). The condition may be at least one of determining, based on information (e.g. a BSR) received from the first network node, that data will have to be transmitted over the backhaul connection, and determining, based on identifying a procedure being performed or to be performed by at least one of the first network node, the relay node or the second network node, that data will have to be transmitted by the relay node over the backhaul connection.

In some examples, determining, based on information received from the first network node, that data will have to be transmitted over the backhaul connection may comprise: receiving information indicating data to be transmitted to the relay node; and determining if the indicated data comprises data to be transmitted over the backhaul connection.

In some examples, transmitting the scheduling assistance information comprises: including, in the scheduling assistance information, information related to data to be transmitted over the backhaul connection from among the data to be transmitted to the relay node; and excluding, from the scheduling assistance information, information related to data not to be transmitted over the backhaul connection from among the data to be transmitted to the relay node.

Referring to FIG. 4, in operation 2, in response to identifying the condition, the relay node transmits, to a second network node (e.g. backhaul gNB) over the backhaul connection, scheduling assistance information (e.g. pre-emptive BSR).

Referring to FIG. 4, in operation 3, data may be received from the first network node and at least part of the data may be forwarded to the second network node.

In one aspect of the disclosure, any type of relay node, such as a WAB, may be configured to pre-emptively signal buffer status reports or other scheduling assistance information based on expected messages that may need to be sent to the core network or to another node. Examples of this may for instance be messages sent from the relay node to an AMF, such as Next Generation Application Protocol (NGAP) messages. An example may be messages that shall be sent from any type of relay node to another radio access node, which can for instance be from the relay node, which may be a gNB, to another gNB. This may for instance be for messages over Xn or any other NB to NB interface.

In one aspect of the disclosure, any type of relay node, such as WAB, may be configured to pre-emptively signal buffer status reports or other scheduling assistance information based on the MAC entity being aware of the destination of the related data. If for instance the relay node knows that certain data is not to be forwarded, the relay node does not trigger a pre-emptive buffer status report or other scheduling assistance information. Similarly, if the relay node knows that the data is to be forwarded to another node, then the relay may trigger the pre-emptive buffer status report.

### Conditions Based on Radio Bearer Type

The conditions for triggering or sending a pre-emptive buffer status report or any other scheduling assistance information by a relaying node may be related to what type of data (user plane or control plane) a UE or another node attaching to said node indicates to be available, and/or the destination of said data, or what type of data or messages that are being sent by a UE or another node to the WAB-gNB.

In one aspect of the disclosure, the pre-emptively sent buffer status report or other scheduling information is not triggered for certain data or based on certain scheduling information sent from a UE or another node based on where the data is terminated. For instance, the pre-emptively sent buffer status report or other scheduling information is not triggered for control plane data originating from the UE. This may be because such control plane data may be control plane data or messages that are terminated in the WAB-node and are not transferred to the core network. Example of such data would be RRC messages such as measurement reports, different types of RRC requests, or similar.

This may also imply that the pre-emptively sent buffer status report or other scheduling information is only triggered for user plane data, for instance data for a Data Radio Bearer (DRBs), originating from the UE or another node. Such user plane data may be messages that are terminated outside the WAB-node. Such messages may be user plane data from a UE. Control plane data that is terminated in the core network of the UE, for instance Non-Access Stratum (NAS) messages may also trigger the pre-emptively sent buffer status report or other scheduling information.

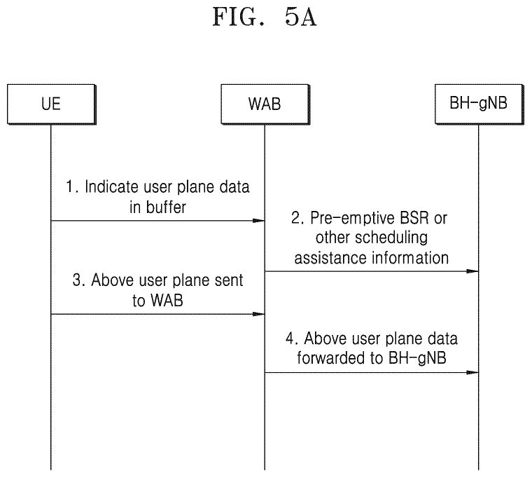

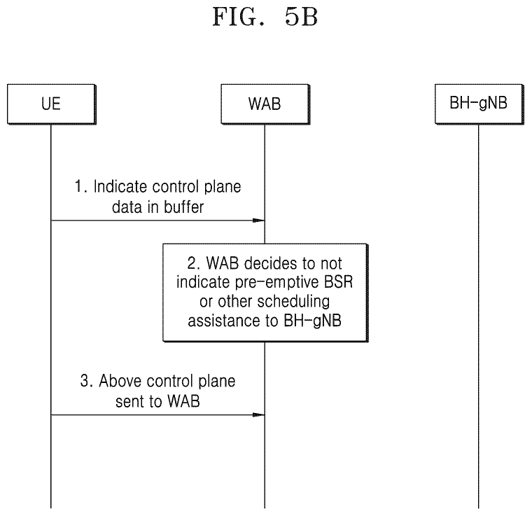

FIG. 5A illustrates an example in which data that will have to be transmitted over the backhaul connection (e.g. user plane data) is indicated to a relay node (e.g. WAB node) according to an embodiment of the disclosure.

Referring to FIG. 5A, in operation 1, the relay node may receive information (e.g. BSR) from the first network node (e.g. UE) indicating data to be transmitted to the relay node. The information may indicate that the data to be transmitted to the relay node is data that will have to be transmitted over the backhaul connection (e.g. user plane data).

Referring to FIG. 5A, in operation 2, if the information indicates that the data to be transmitted to the relay node is data that will have to be transmitted over the backhaul connection, the relay node may transmit, to the second network node over the backhaul connection, scheduling assistance information (e.g. pre-emptive BSR).

Referring to FIG. 5A, in operation 3, the relay node may receive the data (e.g. user plane data) to be transmitted over the backhaul connection.

Referring to FIG. 5A, in operation 4, the relay node may transmit the data (e.g. user plane data) to the second network node (e.g. BH gNB).

FIG. 5B illustrates an example in which data that will not have to be transmitted over the backhaul connection (e.g. control plane data) is indicated to a relay node (e.g. WAB node) according to an embodiment of the disclosure.

Referring to FIG. 5B, in operation 1, the relay node may receive information (e.g. BSR) from the first network node (e.g. UE) indicating data to be transmitted to the relay node. The information may indicate that the data to be transmitted to the relay node is data that will not have to be transmitted over the backhaul connection (e.g. control plane data).

Referring to FIG. 5B, in operation 2, if the information indicates that the data to be transmitted to the relay node is data that will not have to be transmitted over the backhaul connection, the relay node may determine not to transmit, to the second network node over the backhaul connection, scheduling assistance information (e.g. pre-emptive BSR).

Referring to FIG. 5B, in operation 3, the relay node may receive the data (e.g. control plane data) not to be transmitted over the backhaul connection.

In order to achieve such filtering of how pre-emptive BSRs are triggered, in one aspect of the disclosure, the WAB may for instance not trigger pre-emptive BSR based on whether data from a specific logical channel or logical channel group that carries a specific type of radio bearer (may be SRB or DRB, or other future types of radio bearers) or its associated logical channel groups are present in a received BSR. Or similarly, if the WAB receives specific types of scheduling requests, which indicates that a specific logical channel or logical channel group that indicates a signaling or data radio bearer having data for transmission do not have allocated uplink resources, the WAB may not trigger pre-emptive BSR.

Similarly, the WAB may for instance trigger pre-emptive BSR based on whether data from a specific logical channel or logical channel group that carries a specific type of radio (may be SRB or DRB, or other future types of radio bearers) or its associated logical channel groups are present in a received BSR. If the WAB receives specific types of scheduling requests, which indicates that a specific logical channel or logical channel group that indicates a signaling or data radio bearer having data for transmission do not have allocated uplink resources, the WAB may trigger pre-emptive BSR.

In one aspect of the disclosure, the network signals specific radio bearers which may or may not trigger pre-emptive BSR. This can for instance be useful as in some cases, the RRC messages such as SRB2 may contain NAS messages, which needs to be forwarded in an NGAP message sent to the BH-gNB to be forwarded to the UE core network. For instance, the WAB is configured with preemptive BSR to only be triggered for user plane or data radio bearers, the network can configure a flag use PreBSR-DRB, as seen in example.

Pre-emptive BSR is currently triggered at the MAC layer. In order for some of the embodiments of the disclosure to work within this framework, in some of the embodiments, additional indication and/or configuration from the RRC to the MAC is provided, for instance to indicate to the MAC layer the type of message being carried in a certain LCH and/or LCG. In an embodiment of the disclosure, triggering or pre-BSR happens at the RRC layer—in other words, decision on whether to trigger pre-BSR or other scheduling assistance information is done at the RRC layer, which then indicates to the MAC layer that pre-BSR should be sent.

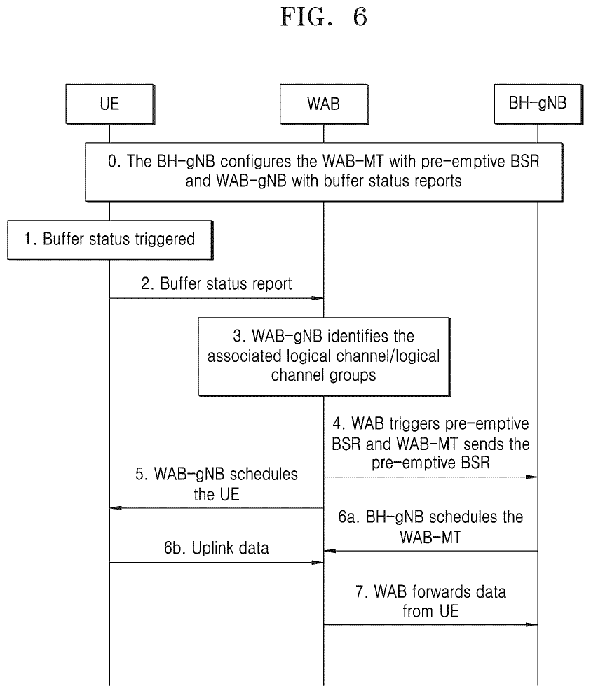

FIG. 6 illustrates a method for pre-emptive BSR according to an embodiment of the disclosure:
0. The second network node (e.g. BH-gNB) configures the relay node (e.g., WAB-MT) with (i.e. to use) pre-emptive signaling assistance information (e.g., pre-emptive BSR) and the relay node (e.g., WAB-gNB) configures the first network node (e.g. UE) with (i.e. to use) buffer status reports.
1. First network node (e.g. UE) receives uplink data in the buffer and triggers a buffer status report.
2. First network node (e.g. UE) sends a Buffer Status report to the relay node (e.g. WAB-gNB).
3. Relay node (e.g. WAB-gNB) identifies the one or more radio bearers associated with the buffer status reports and determines whether to trigger pre-emptive signaling assistance information (e.g. a pre-emptive BSR) to the second network node (BH-gNB).
4. Relay node (e.g. WAB) triggers pre-emptive signaling assistance information (e.g. a pre-emptive BSR) and relay node (e.g. WAB-MT) sends the pre-emptive signaling assistance information (e.g. pre-emptive BSR) over the backhaul link to the second network node (BH-gNB).
5. The relay node (e.g. WAB-gNB) schedules the first network node (UE) to transmit in the uplink. This may for instance be done via an uplink grant.

6a. The second network node (e.g. BH-gNB) schedules the relay node (e.g. WAB-MT) to transmit in the uplink based on the received pre-emptive signaling assistance information (e.g. pre-emptive BSR).
6b. The first network node (e.g. UE) transmits in the uplink.
7. The relay node (e.g. WAB-MT) may forward the received uplink transmission to the second network node (BH-gNB), which may then be backhauled through the backhaul core network to an entity such as the AMF or the UPF of the UEs core network.

In one aspect of the disclosure, when a WAB calculates the size of the pre-emptive BSR, i.e. the buffer that the WAB would have after receiving the uplink data from the UE, the WAB may calculate the buffer based on expect size after the encapsulation has been performed. In other words, the size of the buffer may add the IP header size etc. in addition to the buffer size in the buffer status report from the UE.

In another aspect of the disclosure, the WAB may add a pre-configured amount of bits to the pre-emptive BSR on top of the received buffer size from a UE. This can be configured by the network. If the network does not configure this, a predefined offset may be used. For instance if a UE indicates that a radio bearer, which shall be able to trigger a pre-emptive BSR has 1400 bits, then the WAB may add a configured 100 bits to account for various headers.

In some examples, transmitting the scheduling assistance information may comprise including, in the scheduling assistance information, information related to data to be transmitted over the backhaul connection from among the data to be transmitted to the relay node; and excluding, from the scheduling assistance information, information related to data not to be transmitted over the backhaul connection from among the data to be transmitted to the relay node.

For example, the WAB may exclude certain radio bearers when calculating the pre-emptive BSR depending on whether those specific radio bearer types may trigger the pre-emptive BSR. In other words, if certain radio bearer associated with logical channels or logical channel groups in the BSR shall not be forwarded or sent to the BH-gNB, then when calculating the pre-emptive BSR, these do not need to be included in the pre-emptive BSR.

### Conditions Based on Expected NGAP/Xn

In one aspect of the disclosure, the WAB triggers a pre-emptive Buffer Status Report based on certain RRC procedures that the UE is performing or is predicted to perform with a WAB-gNB (terminated/originating from UE/WAB-gNB). This may mean that certain control plane procedures may trigger pre-emptive BSRs. This can for instance be important when a control plane procedure of a UE triggers messages that shall be forwarded, or other messages that may be triggered to any of the BH-gNB, the BH core network or the UE's core network, for instance when something is to be sent over NGAP to the UE's AMF. It may also be important if the WAB expects that a UE procedure may trigger inter-node messages, i.e. messages to another gNB over Xn to be sent. In this case the WAB may have to backhaul the Xn messages to the BH-gNB which then sends the Xn messages to another gNB.

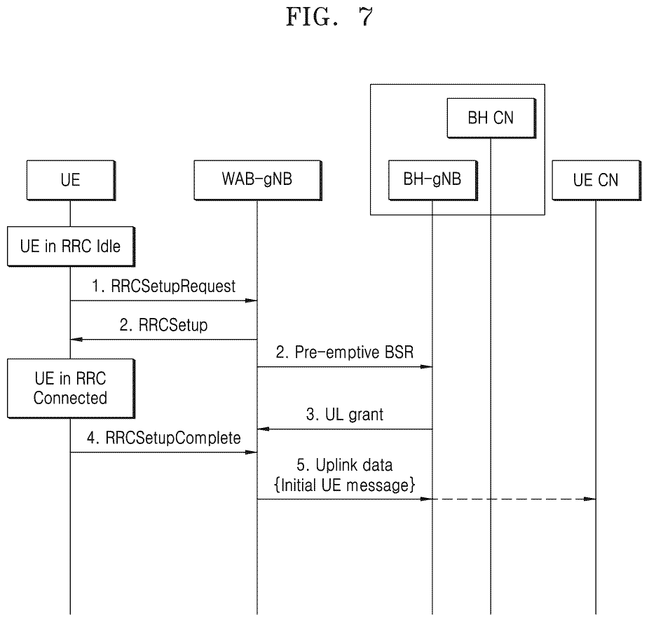

In one aspect of the disclosure, the WAB triggers a pre-emptive BSR during the RRC Setup procedure of a UE. This can for instance be in response to the WAB-gNB sending an RRCSetup message to a UE, or it may be in response to receiving an RRCSetupRequest from a UE. This is important, because the UE may include a NAS message in the RRCSetupComplete message, which needs to be sent over the NGAP interface and thus backhauled to the UEs AMF via the BH-gNB and BH CN. This message may be the INITIAL CONTEXT SETUP REQUEST or INITIAL UE MESSAGE message that is sent from an NG-RAN to an AMF. The expectation that INITIAL CONTEXT SETUP REQUEST or INITIAL UE MESSAGE will be sent may also be considered to be the trigger that triggers the pre-emptive BSR. To have to wait for uplink scheduling for this case may delay the setup procedures. An example of this type of procedure can be seen in FIG. 7.

FIG. 7 illustrates an example of the relay node determining based on identifying a procedure being performed by the first network node or based on identifying a procedure to be performed by the first network node, that data will have to be transmitted over the backhaul connection according to an embodiment of the disclosure.

The UE may initially be in RRC Idle. Referring to FIG. 7, in operation 1, the UE may transmit an RRCSetupRequest message to the WAB-gNB.

Referring to FIG. 7, in operation 2, the WAB-gNB may transmit an RRCSetup message to the UE so that the UE may move to RRC Connected, and may determine, based on the RRC setup procedure, that data will have to be transmitted over the backhaul connection. In response to the determination, the WAB-gNB may transmit, to the BH-gNB, a pre-emptive BSR.

Referring to FIG. 7, in operation 3, the WAB-gNB may receive, from the BH-gNB, an UL grant.

Referring to FIG. 7, in operation 4, the WAB-gNB may receive, from the UE, an RRCSetupComplete message which may include a NAS message/initial UE message, such as INITIAL CONTEXT SETUP REQUEST or INITIAL UE MESSAGE.

Referring to FIG. 7, in operation 5, the WAB-gNB may transmit, to the UE CN (via the BH-gNB and BH-CN), the uplink data including the initial UE message.

In another aspect of the disclosure, if a UE triggers an RRC resume procedure, i.e. a procedure to enter RRC_CONNECTED from RRC_INACTIVE, the UE may trigger a pre-emptive BSR. This can be triggered based on WAB gNB receiving an RRC Resume Request or transmitting an RRC Resume message to a UE. It can also be considered to be triggered based on expecting to transmit the RRC INACTIVE TRANSITION REPORT or a UE CONTEXT RESUME REQUEST to an AMF (or other core network entity).

In one aspect of the disclosure, the NAS transport may trigger a pre-emptive BSR. For instance, if the WAB-gNB anticipates an uplink NAS message to be sent to an AMF (or other core network entity), the WAB-gNB may pre-emptively send a pre-emptive BSR.

In another aspect of the disclosure, if the WAB-gNB expects a UE CONTEXT RESUME REQUEST to be sent to an AMF (or other core network entity) or a PATH SWITCH REQUEST, then the WAB-gNB may trigger a pre-emptive BSR. This may be in response to a UE performing an RRC resume procedures, re-establishment or due to UE performing a handover. For instance, since a PATH SWITCH REQUEST may be sent to an AMF during a handover procedure after the UE has successfully synchronized to the cell, the WAB-gNB may trigger a pre-emptive BSR during the handover procedure.

A paging attempt may also trigger the WAB-gNB to send a pre-emptive BSR. This would be reserved for any type of signaling required during the UE performing paging. This may for instance be triggered when or in response to the WAB-gNB sending a Paging message to a UE.

The following further messages may trigger a pre-emptive BSR if they are expected to be transmitted by a gNB to an AMF:
UE CONTEXT RELEASE REQUEST
RAN CP RELOCATION INDICATION
RETRIEVE UE INFORMATION
HANDOVER REQUIRED
HANDOVER NOTIFICATION
HANDOVER CANCEL
UPLINK RAN STATUS TRANSFER
UPLINK RAN EARLY STATUS TRANSFER
UPLINK NAS TRANSPORT

In another set of aspects of the disclosure, the WAB-gNB may trigger a pre-emptive buffer status report based on expected messages sent over inter-node interface such as Xn.

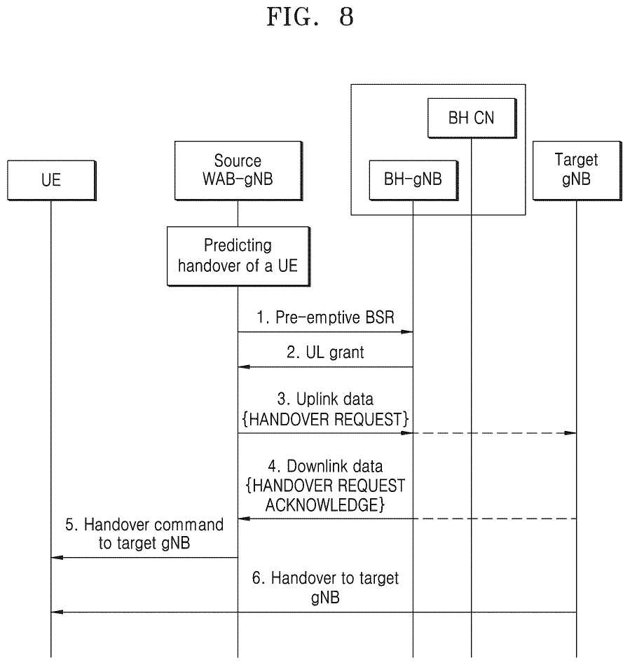

In one aspect of the disclosure, the UE may trigger a pre-emptive buffer status report based on expected HANDOVER REQUEST messages from WAB-gNB to target RAN node (target may be another WAB-gNB or any type of RAN node). This may also be triggered based on the WAB-gNB predicting a handover would soon need to be performed. An example of this type of process is illustrated in FIG. 8. For instance, the WAB-gNB may be a mobile node that may need to handover a lot of UEs at the same time. This may for instance be in the case that a WAB-MT performs a handover and changes its backhaul gNB. In this case, the WAB-gNB may be able to trigger the pre-emptive BSR to ensure that handover procedure may be as fast as possible. The WAB-gNB may also use knowledge of UE signal quality or UE signal strength to predict the WAB-gNB needing to send a HANDOVER REQUEST to another gNB.

FIG. 8 illustrates an example of pre-emptive scheduling assistance information during handover according to an embodiment of the disclosure. The source WAB-gNB may predict that a handover will soon be performed. For example, the source WAB-gNB may identify that a handover will be (or should be) performed within a predetermined or preconfigured duration from the present time. Referring to FIG. 8, in the case that the WAB-gNB predicts a handover, in operation 1, the source WAB-gNB may transmit pre-emptive scheduling assistance information (e.g. pre-emptive BSR) to the BH-gNB.

Referring to FIG. 8, in operation 2, the source WAB-gNB may receive, from the BH-gNB, an UL grant.

Referring to FIG. 8, in operation 3, the source WAB-gNB may transmit, to the target gNB (via the BH-gNB and BH-CN) uplink data, for example including a handover request.

Referring to FIG. 8, in operation 4, the source WAB-gNB may receive, from the target gNB (via the BH-gNB and BH-CN), downlink data, for example including a handover request acknowledgement.

Referring to FIG. 8, in operation 5, for example in response to receiving the handover request acknowledgement, the source WAB-gNB may transmit a handover command to the UE.

Referring to FIG. 8, in operation 6, the UE may be handed over to the target gNB.

Other mobility-related messages that may trigger the pre-emptive BSR, for instance if the message is triggered to be sent, or in advance where it is predicted that the message will be sent, where the WAB-gNB may either be the target or the source gNB:
HANDOVER REQUEST ACKNOWLEDGE
SN STATUS TRANSFER
HANDOVER CANCEL
RETRIEVE UE CONTEXT REQUEST/RESPONSE
RAN PAGING
XN-U ADDRESS INDICATION
UE CONTEXT RELEASE
HANDOVER SUCCESS
CONDITIONAL HANDOVER CANCEL
EARLY STATUS TRANSFER

Other procedures may also trigger pre-emptive BSRs where the WAB-gNB is the initiating node, source node, first node or old RAN node. Procedures may also trigger the pre-emptive BSR where the WAB-gNB is that receiving node, target node, secondary node or new RAN node.

The above may mean that the RRC of the WAB-gNB may indicate to the MAC layer of the WAB-MT to trigger a pre-emptive BSR.

In one aspect of the disclosure, the WAB-gNB may be configured by the network to trigger pre-emptive BSR for specific cases. For instance, the WAB-gNB may configured by the network to trigger BSR based only on the handover procedure. This may for instance mean that the WAB-gNB is only allowed to trigger pre-emptive BSR based on expecting that messages such as PATH SWITCH REQUEST, HANDOVER REQUIRED, HANDOVER NOTIFICATION, HANDOVER CANCEL, HANDOVER REQUEST, HANDOVER REQUEST ACKNOWLEDGE etc. may trigger the pre-emptive BSR. In an example, if any setup procedure is allowed to trigger the pre-emptive BSR, this may for instance mean that the messages INITIAL UE MESSAGE, INITIAL UE CONTEXT SETUP, PATH SWITCH REQUEST, RRC INACTIVE TRANSITION REPORT, UE CONTEXT RESUME REQUEST etc. may trigger a pre-emptive BSR.

### Scheduling Assistance Information

In one aspect of the disclosure, the pre-emptive BSR or any other pre-emptive (or otherwise) scheduling information includes an indication of what triggered the sending of said information. For instance, if, a data radio bearer triggered a pre-emptive BSR, then this may be indicated. If a handover or RRC setup procedure triggered the pre-emptive BSR, then this may be indicated to the backhauling gNB. This can be useful in assigning priority to certain messages over the other. If a new UE or relay node of a certain type or category has attached or requested access, then this may be indicated. In a multi-hop extension of WAB, where WAB connects to another WAB and not directly to a BH-gNB, the number of hops the data needs to traverse to reach the BH-gNB may also be indicated.

### Other

The WAB node, or other relay or repeater node, may either be configured by its backhaul gNB or donor gNB to pre-emptively send a buffer status report, or this may be default operation that does not need to be configured.

In one aspect of the disclosure, if the already existing pre-emptive BSR (the RRC configuration userPreBSR-r16 in MAC-CellGroupConfig) is configured for a WAB-MT, the methods in this disclosure may apply, and the WAB-gNB and the IAB methods for triggering the pre-emptive BSR may not be applicable. In other words, if a WAB-gNB is configured with pre-emptive BSR, the WAB-gNB does not apply the IAB methods.

In another aspect of this disclosure, if the already existing pre-emptive BSR (the RRC configuration userPreBSR-r16 in MAC-CellGroupConfig) is configured for a WAB-MT, the pre-emptive BSR may apply, while the methods in this disclosure will apply when configured using dedicated new signaling.

Extended pre-emptive BSR may also be applicable to a WAB-gNB. The extended pre-emptive BSR may for instance be applicable if the network configures the logicalChannelGroupIAB, or the network may configure a WAB-specific configuration. In one aspect of the disclosure, the extended pre-emptive BSR is considered to be supported by the WAB. This means that if any type of pre-emptive BSR is configured to the WAB, then the WAB uses the extended pre-emptive BSR.

The WAB-MT may indicate to a BH-gNB its capability to support pre-emptive BSR.

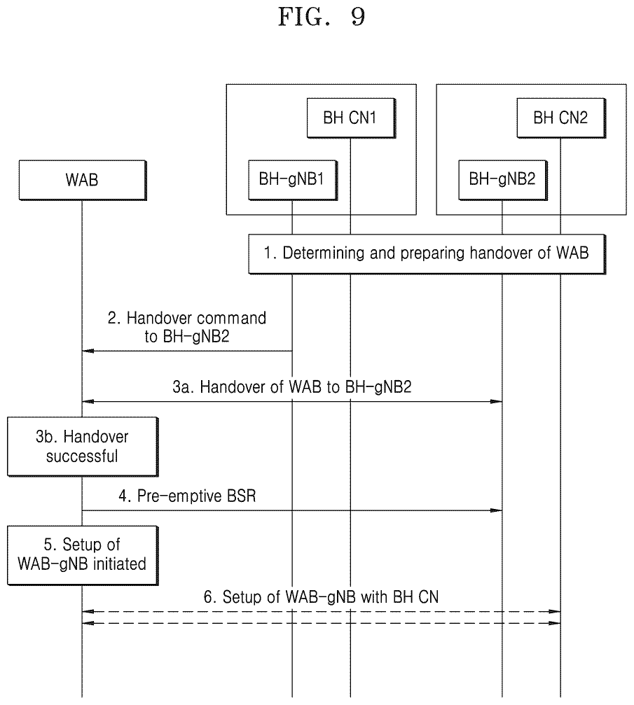

In one aspect of the disclosure, the WAB-MT may be configured to trigger a pre-emptive BSR after the WAB-MT has performed a handover. This may be required for two reasons. One reason is that the WAB-MT may need to send a number of messages in order to establish the backhauling channel. This for instance includes messages to setup the NGAP setup between WAB-gNB and the BH AMF, BH UPF or BH CN. An example of this type of process is illustrated in FIG. 9. The pre-emptive BSR may also be needed in order for the WAB to handle UEs performing handover to and from the WAB-gNB. This may for instance be if the UEs AMF changes, or there is a new tracking area signaled by the WAB.

FIG. 9 illustrates an example of pre-emptive scheduling assistance information triggered as WAB-MT is handed over according to an embodiment of the disclosure.

Referring to FIG. 9, in operation 1, the first (i.e. source) and second (i.e. target) BH gNBs/CNs may determine and prepare to hand over the WAB.

Referring to FIG. 9, in operation 2, the first BH-gNB may transmit a handover command to the WAB, indicating that the WAB should be handed over to the second BH-gNB.

Referring to FIG. 9, in operation 3a, the handover to the second BH-gNB may be performed, and in operation 3b the WAB may determine that the handover has been successful.

Referring to FIG. 9, in operation 4, in response to determining that the handover has been successful, the WAB may transmit pre-emptive scheduling assistance information (e.g. pre-emptive BSR) to the second BH-gNB.

Referring to FIG. 9, in operation 5, setup of the WAB-gNB may be initiated.

Referring to FIG. 9, in operation 6, setup of the WAB-gNB may be performed with the second BH-CN (via the second BH-gNB).

The pre-emptive buffer status report may be used in a setting where the relay node is in a dual connectivity setting. Such a dual connectivity setting may for instance mean that the relay node, such as a WAB node, has two backhaul gNBs and two backhaul core networks, for instance if each BH node connects to different core networks. In this case, the pre-emptive BSR is triggered for each backhaul gNB depending on the destination. This for instance means that the buffer status report received on one should not be taken to include the full WAB buffer, but only the buffer for each backhaul node. This may be important, as a WAB may not have any other means of routing data.

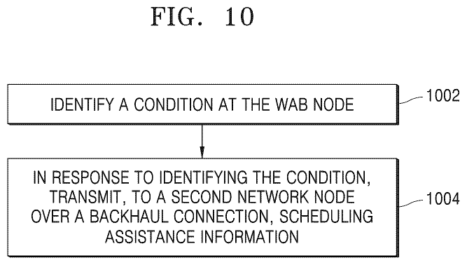

FIG. 10 illustrates an example method of a WAB node in a communication network according to an embodiment of the disclosure.

In operation 1002, the method comprises identifying a condition at the WAB node.

In operation 1004, in response to identifying the condition, the method comprises transmitting, to a second network node (e.g. gNB) over a backhaul connection, scheduling assistance information.

The condition may be at least one of: determining, based on a buffer status report (BSR) received from a first network node (e.g. a UE), that data will have to be transmitted over the backhaul connection; and determining, based on identifying a procedure being performed, to be performed, or having been performed by at least one of the first network node, the WAB node or the second network node, that data will have to be transmitted by the WAB node over the backhaul connection.

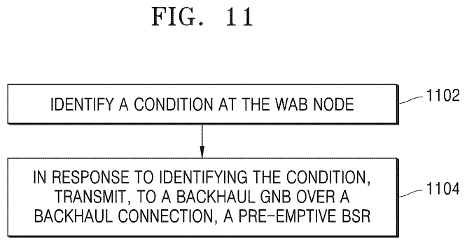

FIG. 11 illustrates an example method of a WAB node in a communication network according to an embodiment of the disclosure.

In operation 1102, the method comprises identifying a condition at the WAB node.

In operation 1104, in response to identifying the condition, the method comprises transmitting, to a backhaul gNB over a backhaul connection, a pre-emptive BSR.

The condition may be at least one of: identifying that an UL grant is provided to a UE in response to a BSR that indicates a logical channel not associated with a system resource block (SRB); identifying that a BSR is received from a UE and that the BSR indicates at least one logical channel not associated with an SRB; identifying a trigger from the RRC layer; and identifying that a message will be sent over at least one of the NGAP and Xn interfaces.

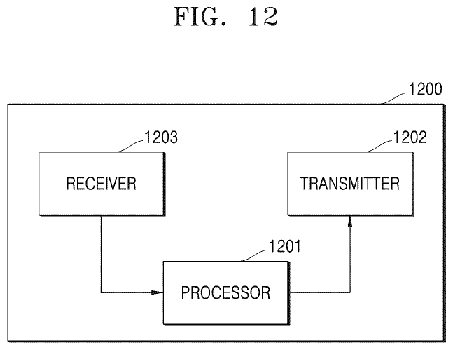

FIG. 12 is a block diagram of a network entity 1200 (e.g. relay node or WAB node) according to an embodiment of the disclosure. The skilled person will appreciate that the network entity 1200 illustrated in FIG. 12 may be implemented, for example, as a network element on a dedicated hardware, as a software instance running on a dedicated hardware, or as a virtualized function instantiated on an appropriate platform, e.g. on a cloud infrastructure.

The network entity 1200 comprises a processor 1201 (or controller), a transmitter 1202, and a receiver 1203. The receiver 1203 is configured for receiving one or more messages from one or more other network entities. The transmitter 1202 is configured for transmitting one or more messages to one or more other network entities. The processor 1201 is configured for performing operations as described above.

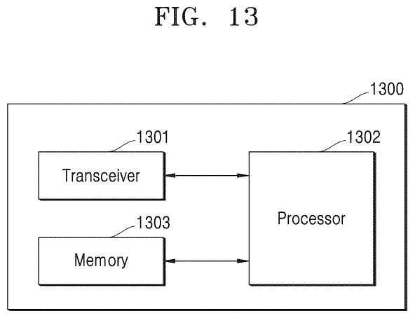

FIG. 13 is a block diagram of a terminal or user equipment (UE) 1300 according to an embodiment of the disclosure.

The terminal is an electronic device capable of wireless communication, may include a User Equipment (UE), a portable phone, a smartphone, a tablet, an Internet of things (IoT) device, etc., having various form factors, and may perform wireless communication with a base station (BS) through a wireless channel.

Referring to FIG. 13, the UE 1300 may include at least one transceiver (hereinafter, referred to as simply “transceiver”) 1301, at least one processor (hereinafter, referred to as simply “processor”) 1302, and at least one memory (hereinafter, referred to as simply “memory”) 1303. According to at least one or a combination of methods corresponding to the embodiments described in the present disclosure, the transceiver 1301, the processor 1302, and the memory 1303 of the UE 1300 may operate. However, components of the UE 1300 are not limited to the exemplary components illustrated in FIG. 13. In another embodiment, the UE 1300 may further include additional components in addition to the above-mentioned components, or some components may be omitted. Further, in some embodiments, any combination of the transceiver 1301, the processor 1302, or the memory 1303 may be integrated in the form of one component.

The transceiver 1301 may be a communication circuit or communication circuitry that enables the UE 1300 to perform wireless communication with a node or an entity of a network. For example, the transceiver 1301 may enable the UE 1300 to transmit or receive a signal to or from a BS through cellular communication, or to transmit or receive a signal to or from another UE through cellular communication. For example, the transceiver 1301 may support at least one of various cellular communication technologies including 3rd generation (3G), 4th generation (4G), long term evolution (LTE), 5th generation (5G) NR, 6th generation (6G), and various cellular wireless communication technologies supported by the transceiver (1301) may include all subsequent generations of evolved wireless communications.

According to an embodiment, the UE 1300 may include a plurality of transceivers. For example, in the case of supporting evolved-universal terrestrial radio access-new radio (E-UTRA-NR) dual connectivity (EN-DC), the UE 1300 may include a first transceiver supporting the 4G LTE wireless communication and a second transceiver supporting the 5G NR wireless communication. According to another embodiment, in the case of supporting NR-dual connectivity (NR-DC), the UE 1300 may include a plurality of transceivers supporting the 5G NR wireless communication. According to still another embodiment, in the case of supporting near field wireless communication, the UE 1300 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 1301 may include various circuit structures used to transmit or receive signals to or from a BS through a wireless channel. The signals may include control information and data. For example, the transceiver 1301 may include a radio frequency (RF) transmitter for up-converting and amplifying the frequency of a transmitted signal and an RF receiver for low-noise-amplifying a received signal and down-converting the frequency thereof. The transceiver 1301 may output a signal received through a wireless channel to the processor 1302 and may transmit, through a wireless channel, a signal output from the processor 1302.

The processor 1302 may control general operations of the UE 1300 according to embodiments of the disclosure. The processor 1302 may be implemented by one or more integrated circuit (or circuitry) (IC) chips and may execute various data processings. The processor 1302 may include at least one electric circuit, and may execute instructions (or a program, codes, data, etc.) stored in the memory 1303, individually, collectively or in any combination thereof. Further, the processor 1302 may include a single-core processor or multi-core processor, and may include a processor assembly including a plurality of processing circuits (circuitry) according to a specific implementation scheme.

The processor 1302 may be electrically, operatively, or communicatively coupled to the transceiver 1301 to control the transceiver 1301.

The processor 1302 may include at least one processor (or processing circuitry), and the at least one processor may perform the following operations individually, collectively or in any combination thereof. For example, the processor 1302 may include a communication processor (CP) configured to control communication operations and an application processor (AP) configured to control execution of an upper layer (for example, an application layer). In a specific embodiment, at least a part of the processor 1302 may be included in one chip and the other part of the processor 1302 may be included in another chip. Otherwise, at least one processor may be included in another component, for example, the transceiver 1301 or the memory 1303.

The processor 1302 may perform or control or cause an operation of the UE 1300 for executing at least one or a combination of methods according to embodiments of the disclosure. For example, the processor 1302 may control operations of the UE 1300 for processing a downlink signal received from a BS or generating and transmitting an uplink signal to a BS. To this end, the processor 1302 may execute a computer program, codes, or instructions stored in the memory 1303, so as to control other components of the UE 1300 to enable execution of various operations.

The memory 1303 corresponds to a hardware storage device capable of temporarily or permanently storing information and may include one or more storage media. For example, the memory 1303 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1303 may be electrically, operatively, or communicatively coupled to the processor 1302 and may be accessed by the processor 1302.

The memory 1303 may store a computer program, codes, or instructions executable by the processor 1302. According to an embodiment, a computer program, codes, or instructions executable by the processor 1302 may be either stored in a single memory device or separated and distributedly stored in two or more memory devices. By executing the instructions stored in the memory 1303, the processor 1302 may perform various functions according to an embodiment of the disclosure.

According to an embodiment of the disclosure, operations of the UE 1300 may be caused to be performed based on execution of instructions (or a computer program or codes) stored in the memory 1303 by at least one processor (or processing circuitry) configured to execute the same individually, collectively, or in any combination thereof, based on processing circuitry that is not configured to execute instructions, and/or based on components of processing circuitry that is not configured to execute instructions.

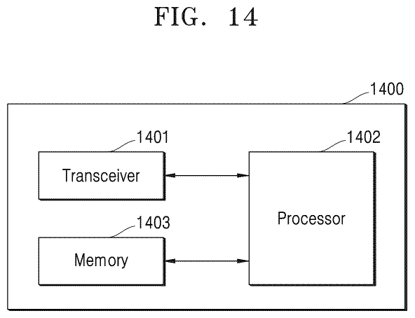

FIG. 14 is a block diagram of a base station (BS) 1400 according to an embodiment of the disclosure.

The BS 1400 may perform wireless communication with at least one user equipment (UE) located within the area of the BS 1400 through a wireless channel.

Referring to FIG. 14, the BS 1400 may include at least one transceiver (hereinafter, referred to as simply “transceiver”) 1401, at least one processor (hereinafter, referred to as simply “processor”) 1402, and at least one memory (hereinafter, referred to as simply “memory”) 1403. According to at least one or a combination of methods corresponding to the embodiments described in the present disclosure, the transceiver 1401, the processor 1402, and the memory 1403 of the BS 1400 may operate. However, components of the BS 1400 are not limited to the exemplary components illustrated in FIG. 14. In another embodiment, the BS 1400 may further include additional components in addition to the above-mentioned components, or some components may be omitted. Further, in some embodiments, any combination of the transceiver 1401, the processor 1402, or the memory 1403 may be integrated in the form of one component.

The transceiver 1401 may be a communication circuit or communication circuitry that enables the BS 1400 to perform wireless communication with a node or an entity of a network. For example, the transceiver 1401 may enable the BS 1400 to transmit or receive a signal to or from the UE X00 through cellular communication, or to transmit or receive a signal to or from another network entity through wireless communication. For example, the transceiver 1401 may support various cellular communication technologies including 3rd generation (3G), 4th generation (4G), long term evolution (LTE), 5th generation (5G) NR, 6th generation (6G), and various cellular wireless communication technologies supported by the transceiver (1401) may include all subsequent generations of evolved wireless communications. According to an embodiment, the transceiver 1401 may include various circuit structures used to transmit or receive signals to or from a UE through a wireless channel. The signals may include control information and data. For example, the transceiver 1401 may include a radio frequency (RF) transmitter for up-converting and amplifying the frequency of a transmitted signal and an RF receiver for low-noise-amplifying a received signal and down-converting the frequency thereof. The transceiver 1401 may output a signal received through a wireless channel to the processor 1402 and may transmit, through a wireless channel, a signal output from the processor 1402.

Meanwhile, according to an embodiment of the present disclosure, the BS 1400 may perform communication with a node or an entity of a network through wired or wireless communication. For example, the BS 1400 may perform wired or wireless communication with an adjacent BS, or a node or an entity of a core network through a backhaul network. Although not illustrated in FIG. 14, when the BS 1400 performs wired communication, the BS 1400 may further include a separate network interface for wired communication in addition to the transceiver 1401. The network interface may be referred to as network interface circuitry or communication interface circuitry.

The processor 1402 may control general operations of the BS 1400 according to embodiments of the disclosure. The processor 1402 may be implemented by one or more integrated circuit (or circuitry) (IC) chips and may execute various data processings. The processor 1402 may include at least one electric circuit, and may execute instructions (or a program, codes, data, etc.) stored in the memory 1403, individually, collectively or in any combination thereof. Further, the processor 1402 may include a single-core processor or multi-core processor, and may include a processor assembly including a plurality of processing circuits (circuitry) according to a specific implementation scheme.

The processor 1402 may be electrically, operatively, or communicatively coupled to the transceiver 1401 to control the transceiver 1401.

The processor 1402 may include at least one processor (or processing circuitry), and the at least one processor may perform the following operations individually, collectively or in any combination thereof. In a specific embodiment, at least a part of the processor 1402 may be included in one chip and the other part of the processor 1402 may be included in another chip. Otherwise, at least one processor may be included in another component, for example, the transceiver 1401 or the memory 1403.

The processor 1402 may perform or control or cause an operation of the BS 1400 for executing at least one or a combination of methods according to embodiments of the disclosure. For example, the processor 1402 may control operations of the BS 1400 for generating and transmitting a downlink signal to a UE or processing an uplink signal received from a UE. Otherwise, the BS 1400 may transmit or receive a signal to or from a neighboring BS, transfer a signal received from a UE to an upper node of the network, or transmit a signal transferred from an upper node of the network to a UE. To this end, the processor 1402 may execute a computer program, codes, or instructions stored in the memory 1403, so as to control other components of the BS 1400 to enable execution of various operations.

The memory 1403 corresponds to a hardware storage device capable of temporarily or permanently storing information and may include one or more storage media. For example, the memory 1403 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1403 may be electrically, operatively, or communicatively coupled to the processor 1402 and may be accessed by the processor 1402.

The memory 1403 may store a computer program, codes, or instructions executable by the processor 1402. According to an embodiment, a computer program, codes, or instructions executable by the processor 1402 may be either stored in a single memory device or separated and distributedly stored in two or more memory devices. By executing the instructions stored in the memory 1403, the processor 1402 may perform various functions according to an embodiment of the disclosure.

According to an embodiment of the disclosure, operations of the BS 1400 may be caused to be performed based on execution of instructions (or a computer program or codes) stored in the memory 1403 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the base station may perform various communication procedures related to the control plane or the user plane by cooperating with one or more network entities based on wireless communication. For example, the UE may communicate with network entity such as an Access and Mobility Management Function (AMF) or a Session Management Function (SMF) via the base station, or the base station may perform at least one communication procedure by directly transmitting and receiving signals to/from, or relaying signals between, the network entities.

The structure of the above-described network entity will be described in more detail with reference to the drawings.

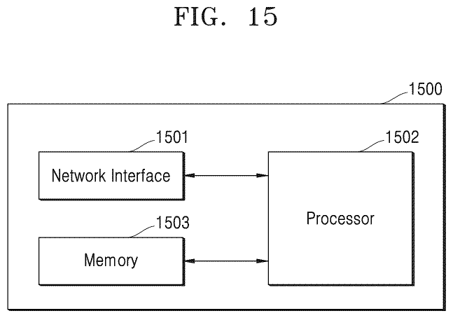

FIG. 15 is a block diagram of a network entity 1500 according to an embodiment of the disclosure.

The network entity 1500 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 1500.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

The NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN).

Referring to FIG. 15, the network entity 1500 may include at least one network interface 1501, at least one processor 1502 (hereinafter, “processor”), and at least one memory 1503 (hereinafter, “memory”). As described above, a NF may be implemented in the form of a physical device such as the network entity 1500, or may be virtualized and executed in the form of an instance. When implemented as an instance, the NF need not necessarily include physical components as illustrated in FIG. 15. In such a case, the instance may be logically represented as comprising one or more logical functional elements.

According to at least one or a combination of methods corresponding to the embodiments described in the present disclosure, the network interface 1501, the processor 1502, and the memory 1503 of the network entity 1500 may operate. However, components of the network entity 1500 are not limited to the exemplary components illustrated in FIG. 15. In another embodiment, the network entity 1500 may further include additional components in addition to the above-mentioned components, or some components may be omitted. Further, in an embodiment, the network interface 1501, the processor 1502, or the memory 1503 may be integrated in the form of one component.

The network interface 1501 is a collective term for a transmitter part of the network entity 1500 and a receiver part of the network entity 1500, and may be a communication circuit for transmitting or receiving a signal to or from a user equipment (UE), a base station (BS), or another network entity. Here, the communication circuit may include both a communication circuit for wireless communication and a communication circuit for a wired communication. For example, the network interface 1501 may include a circuit, logic, hardware, etc., configured to exchange a control plane message or a user plane message with a UE, a BS, or other core network entities through wireless communication or wired communication. The network interface 1501 may operate using various protocols (e.g., non-access stratum (NAS) protocol). The network interface 1501 may also be referred to, for convenience of description or depending on implementation, as communication circuitry, network interface circuitry, or a communication interface circuitry.

The processor 1502 may control general operations of the network entity 1500 according to embodiments of the disclosure. The processor 1502 may be implemented by one or more integrated circuit (or circuitry) (IC) chips and may execute various data processings. The processor 1502 may include at least one electric circuit, and may execute instructions (or a program, codes, data, etc.) stored in the memory 1503, individually, collectively or in any combination thereof. Further, the processor 1502 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 1502 may be electrically, operatively, or communicatively coupled to the network interface 1501 to control the network interface 1501.

The processor 1502 may include at least one processor (or processing circuitry), and the at least one processor may perform the following operations individually, collectively or in any combination thereof. In a specific embodiment, at least a part of the processor 1502 may be included in one chip and the other part of the processor 1502 may be included in another chip. Otherwise, at least one processor may be included in another component, for example, the network interface 1501 or the memory 1503.

The processor 1502 may perform or control or cause an operation of the network entity 1500 for executing at least one or a combination of methods according to embodiments of the disclosure. For example, the processor 1502 may control operations of the network entity 1500 for exchanging a control plane message or a user plane message with a UE, a BS, or other core network entities through wireless or wired communication, using various protocols (e.g., NAS protocol). To this end, the processor 1502 may execute a computer program, codes, or instructions stored in the memory 1503, so as to control other components of the network entity 1500 to enable execution of various operations.

The memory 1503 corresponds to a hardware storage device capable of temporarily or permanently storing information and may include one or more storage media. For example, the memory 1503 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1503 may be electrically, operatively, or communicatively coupled to the processor 1502 and may be accessed by the processor 1502.

The memory 1503 may store a computer program, codes, or instructions executable by the processor 1502. According to an embodiment, a computer program, codes, or instructions executable by the processor 1502 may be either stored in a single memory device or separated and distributedly stored in two or more memory devices. By executing the instructions stored in the memory 1503, the processor 1502 may perform various functions according to an embodiment of the disclosure.

According to an embodiment of the disclosure, operations of the network entity 1500 may be caused to be performed based on execution of instructions (or a computer program or codes) stored in the memory 1503 by at least one processor (or processing circuitry) configured to execute the same individually, collectively, or in any combination thereof, based on processing circuitry that is not configured to execute instructions, and/or based on components of processing circuitry that is not configured to execute instructions.

### SPECIFICATION EXAMPLES

There follows examples of changes to the existing 3GPP standards based on the disclosure. Changes are shown in bold typeface.

### ---------------38.321 Release 18 V18.2.0---------------

### 5.4.7 Pre-Emptive Buffer Status Reporting

The Pre-emptive Buffer Status reporting (Pre-emptive BSR) procedure is used by an IAB-MT or WAB-MT to provide its parent IAB-DU(s), IAB-donor-DU(s) or BH-gNB with the information about the amount of the data expected to arrive at the IAB-MT or WAB-MT from its child node(s) and/or UE(s) connected to it.

If configured, Pre-emptive BSR may be triggered for the specific case of an IAB-MT or WAB-MT if any of the following events occur:
UL grant is provided to child IAB node or UE;
UL grant is provided to UE in response to a BSR that indicates a logical channels not associated with an SRB;
BSR is received from child IAB node or UE.
BSR is received from a UE and the BSR indicates a logical channels not associated with an SRB.
Triggered by RRC layer (for WAB-MT)

IAB-MT or WAB-MT may report Extended Pre-emptive BSR (as defined in clause 6.1.3.1) if the MAC entity of the IAB-MT or WAB-MT is configured with logicalChannelGroupIAB-Ext by upper layers. Otherwise IAB-MT or WAB-MT may report Pre-emptive BSR (as defined in clause 6.1.3.1).

The MAC entity shall:
1> if the Pre-emptive Buffer Status reporting procedure determines that at least one Pre-emptive BSR has been triggered and not cancelled:
2> if UL-SCH resources are available for a new transmission and the UL-SCH resources can accommodate the Extended Pre-emptive BSR or Pre-emptive BSR MAC CE plus its subheader as a result of logical channel prioritization:
3> instruct the Multiplexing and Assembly procedure to generate the Extended Pre-emptive BSR or Pre-emptive BSR MAC CE as defined in clause 6.1.3.1.
2> else:
3> trigger a Scheduling Request.

A MAC PDU shall contain at most one Pre-emptive BSR MAC CE or Extended Pre-emptive BSR MAC CE, even when multiple events have triggered a Pre-emptive BSR.

All triggered Pre-emptive BSR(s) shall be cancelled when a MAC PDU is transmitted and this PDU includes the corresponding Pre-emptive BSR MAC CE or Extended Pre-emptive BSR MAC CE.

NOTE: Pre-emptive BSR may be used for the case of dual-connected IAB node. It is up to network implementation to work out the associated MAC entity or entities which report the Pre-emptive BSR, and the associated expected amount of data reported by any such entity or entities. For the case of dual-connected IAB node, if two ingress BH RLC channels belonging to the same ingress LCG are mapped to two different egress Cell Groups (corresponding to different parent nodes), there may be ambiguity in Pre-emptive BSR calculations and interpretation by the receiving parent node(s) and the IAB node reporting pre-emptive BSR.

### ---------------38.321 Release 18 V18.2.0---------------

### Example #1b

### ---------------38.331 Release 18 V18.2.0---------------

### MAC-CellGroupConfig

The IE MAC-CellGroupConfig is used to configure MAC parameters for a cell group, including DRX.

MAC-CellGroupConfig information element

-- ASN1START
-- TAG-MAC-CELLGROUPCONFIG-START

| MAC-CellGroupConfig ::= | SEQUENCE ( | |
|---|---|---|
| drx-config | SetupRelease [symbol] DRX-Config [symbol] | OPTIONAL, -- Need M |
| schedulingRequestConfig | SchedulingRequestConfig | OPTIONAL, -- Need M |
| bsr-Config | BSR-Config | OPTIONAL, -- Need M |
| tag-Config | TAG-Config | OPTIONAL, -- Need M |
| phr-Config | SetupRelease [symbol] PHR-Config [symbol] | OPTIONAL, -- Need M |

| | |
|---|---|
| skipUplinkTxDynamic | BOOLEAN, |

```
  ...,
  [[
```

| | | |
|---|---|---|
| csi- [symbol] | BOOLEAN | OPTIONAL, -- Need M |
| dataInactivityTimer | SetupRelease [symbol] DataInactivityTimer [symbol] | OPTIONAL, -- Cond [symbol] - |

```
Only
  ]],
  [[
```

| | | |
|---|---|---|
| usePreBSR-r16 | ENUMERATED [symbol] true [symbol] [symbol] | OPTIONAL, -- Need R |
| schedulingRequestID-L [symbol] -SCell-r16 | SchedulingRequestId [symbol] | OPTIONAL, -- Need R |
| lch- [symbol] asedPrioritization-r16 | ENUMERATED [symbol] enabled [symbol] | OPTIONAL, -- Need R |
| schedulingRequestID-B [symbol] R-SCell-r [symbol] | SchedulingRequestId | OPTIONAL, -- Need R |

| | |
|---|---|
| drx-ConfigSecondaryGroup-r16 | SetupRelease [symbol] DRX-ConfigSecondaryGroup-r16 [symbol] |

```
OPTIONAL -- Need M
  ]],
  [[
```

| | | |
|---|---|---|
| enhancedSkipUplinkTxDynamic-r16 | ENUMERATED [symbol] true [symbol] [symbol] | OPTIONAL, -- Need R |
| enhancedSkipUplinkTxConfigured-r16 | ENUMERATED [symbol] true [symbol] [symbol] | OPTIONAL, -- Need R |

```
  ]],
  [[
```

. . . OMITTED . . .

```
  ]],
  [[
```

| | | |
|---|---|---|
| schedulingRequestID-Po [symbol] MG-Request- [symbol] 1 [symbol] | SchedulingRequestId | OPTIONAL, -- Need R |
| drx-LastTransmissionDL-r17 | ENUMERATED [symbol] enabled [symbol] | OPTIONAL, -- Need [symbol] |

```
  ]],
  [[
```

| | | |
|---|---|---|
| [symbol] -Request-r17 | ENUMERATED [symbol] enabled [symbol] | OPTIONAL, -- Need [symbol] |

```
  ]],
  [[
```

| | | |
|---|---|---|
| drx-ConfigExt2-v1800 | SetupRelease [symbol] DRX-ConfigExt2-v1800 [symbol] | OPTIONAL, -- Need M |
| additional [symbol] -TableAllowed-r18 | BIT STRING (SIZE (maxNroff [symbol] -r18 [symbol] | OPTIONAL, -- Need R |

| | |
|---|---|
| dsr-ConfigToAddModList-r18 | SEQUENCE (SIZE (1..maxNrofL [symbol] s-r18 [symbol] ) OF LC [symbol] -DSR-Config-r18 |

OPTIONAL, -- Need N

| | |
|---|---|
| dsr-ConfigToReleaseList-r18 | SEQUENCE (SIZE (1..maxNrofL [symbol] s-r18 [symbol] ) OF LC [symbol] -Id-r18 |

OPTIONAL, -- Need N

| | | |
|---|---|---|
| [symbol] -Config-r18 | SetupRelease [symbol] -Config-r18 [symbol] | OPTIONAL, -- Need M |

```
  ]],
  [[
```

| | | |
|---|---|---|
| userPreBSR-DRB-r19 | ENUMERATED [symbol] true [symbol] | OPTIONAL, -- Need R |

]]

[symbol]

. . . OMITTED . . .

-- TAG-MAC-CELLGROUPCONFIG-STOP
-- ASN1STOP [symbol]
indicates data missing or illegible when filed

### MAC-CellGroupConfig

The IE MAC-CellGroupConfig is used to configure MAC parameters for a cell group, including DRX.

MAC-CellGroupConfig information element

-- ASN1START
-- TAG-MAC-CELLGROUPCONFIG-START

| MAC-CellGroupConfig ::= | SEQUENCE ( | |
|---|---|---|
| drx-config | SetupRelease [symbol] DRX-Config [symbol] | OPTIONAL, -- Need M |
| schedulingRequestConfig | SchedulingRequestConfig | OPTIONAL, -- Need M |
| bsr-Config | BSR-Config | OPTIONAL, -- Need M |
| tag-Config | TAG-Config | OPTIONAL, -- Need M |
| phr-Config | SetupRelease [symbol] PHR-Config [symbol] | OPTIONAL, -- Need M |

| | |
|---|---|
| skipUplinkTxDynamic | BOOLEAN, |

```
  ...,
  [[
```

| | | |
|---|---|---|
| csi- [symbol] | BOOLEAN | OPTIONAL, -- Need M |
| dataInactivityTimer | SetupRelease [symbol] DataInactivityTimer [symbol] | OPTIONAL, -- Cond M [symbol] |

```
Only
  ]],
  [[
```

| | | |
|---|---|---|
| usePreBSR-r16 | ENUMERATED [symbol] true [symbol] | OPTIONAL, -- Need R |
| schedulingRequestID-L [symbol] -SCell-r16 | SchedulingRequestId | OPTIONAL, -- Need R |
| lch- [symbol] asedPrioritization-r16 | ENUMERATED [symbol] enabled [symbol] | OPTIONAL, -- Need R |
| schedulingRequestID-B [symbol] -SCell-r [symbol] | SchedulingRequestId | OPTIONAL, -- Need R |

| | |
|---|---|
| drx-ConfigSecondaryGroup-r16 | SetupRelease [symbol] DRX-ConfigSecondaryGroup-r16 [symbol] |

```
OPTIONAL -- Need M
  ]],
  [[
```

. . . OMITTED . . .

```
  ]],
  [[
```

| | | |
|---|---|---|
| drx-ConfigExt2-v1800 | SetupRelease [symbol] DRX-ConfigExt2-v1800 [symbol] | OPTIONAL, -- Need M |
| additional [symbol] -TableAllowed-r18 | BIT STRING (SIZE (maxNroff [symbol] -r18 [symbol] | OPTIONAL, -- Need R |

| | |
|---|---|
| dsr-ConfigToAddModList-r18 | SEQUENCE (SIZE (1..maxNrofL [symbol] s-r18 [symbol] ) OF L [symbol] -DSR-Config-r18 |

OPTIONAL, -- Need N

| | |
|---|---|
| dsr-ConfigToReleaseList-r18 | SEQUENCE (SIZE (1..maxNrofL [symbol] -r18 [symbol] ) OF LC [symbol] -Id-r18 |

OPTIONAL, -- Need N

| | | |
|---|---|---|
| [symbol] -Config-r18 | SetupRelease [symbol] -Config-r18 [symbol] | OPTIONAL, -- Need M |

```
  ]],
  [[
```

| | | |
|---|---|---|
| userPreBSR-DRB-r19 | ENUMERATED [symbol] true [symbol] | OPTIONAL, -- Need R |

]]

[symbol]

. . . OMITTED . . .

-- TAG-MAC-CELLGROUPCONFIG-STOP
-- ASN1STOP [symbol]
indicates data missing or illegible when filed

MAC-CellGroupConfig field descriptions
. . . OMITTED . . .

usePreBSR
If set to true, the MAC entity of the IAB-MT may use the Pre-emptive BSR, see TS 38.321 [3].
usePreBSR-DRB
If set to true, the MAC entity of the WAB-MT or others may use the Pre-emptive BSR for Data Radio Bearers, see
TS 38.321 [3].

### ---------------38.331 Release 18 V18.2.0---------------

### Example #2

Specification changes in bold.

### ---------------38.321 Release 18 V18.2.0---------------

### 5.4.7 Pre-Emptive Buffer Status Reporting

The Pre-emptive Buffer Status reporting (Pre-emptive BSR) procedure is used by an LAB-MT to provide its parent IAB-DU(s) or IAB-donor-DU(s) with the information about the amount of the data expected to arrive at the IAB-MT from its child node(s) and/or UE(s) connected to it.

If configured, Pre-emptive BSR may be triggered for the specific case of an IAB-MT if any of the following events occur:
UL grant is provided to child IAB node or UE;
BSR is received from child IAB node or UE.
Triggered by UE RRC procedures by the WAB-gNB, as described in 38.300.

IAB-MT may report Extended Pre-emptive BSR (as defined in clause 6.1.3.1) if the MAC entity of the IAB-MT is configured with logicalChannelGroupIAB-Ext by upper layers. Otherwise IAB-MT may report Pre-emptive BSR (as defined in clause 6.1.3.1).

The MAC entity shall:
1> if the Pre-emptive Buffer Status reporting procedure determines that at least one Pre-emptive BSR has been triggered and not cancelled:
2> if UL-SCH resources are available for a new transmission and the UL-SCH resources can accommodate the Extended Pre-emptive BSR or Pre-emptive BSR MAC CE plus its subheader as a result of logical channel prioritization:
3> instruct the Multiplexing and Assembly procedure to generate the Extended Pre-emptive BSR or Pre-emptive BSR MAC CE as defined in clause 6.1.3.1.
2> else:
3> trigger a Scheduling Request.

A MAC PDU shall contain at most one Pre-emptive BSR MAC CE or Extended Pre-emptive BSR MAC CE, even when multiple events have triggered a Pre-emptive BSR.

All triggered Pre-emptive BSR(s) shall be cancelled when a MAC PDU is transmitted and this PDU includes the corresponding Pre-emptive BSR MAC CE or Extended Pre-emptive BSR MAC CE.

NOTE: Pre-emptive BSR may be used for the case of dual-connected IAB node. It is up to network implementation to work out the associated MAC entity or entities which report the Pre-emptive BSR, and the associated expected amount of data reported by any such entity or entities. For the case of dual-connected IAB node, if two ingress BH RLC channels belonging to the same ingress LCG are mapped to two different egress Cell Groups (corresponding to different parent nodes), there may be ambiguity in Pre-emptive BSR calculations and interpretation by the receiving parent node(s) and the IAB node reporting pre-emptive BSR.

### ---------------38.321 Release 18 V18.2.0---------------

### ---------------38.331 Release 18 V18.2.0---------------

### 10.4 Measurements to Support Scheduler Operation

Measurement reports are required to enable the scheduler to operate in both uplink and downlink. These include transport volume and measurements of a UEs radio environment.

Uplink buffer status reports (BSR) are needed to provide support for Quality of Service (QoS)-aware packet scheduling. In NR, uplink buffer status reports refer to the data that is buffered in for a group of logical channels (LCG) in the UE. Four formats are used for reporting in uplink:
A short format to report only one BSR (of one LCG);
A flexible long format to report several BSRs (up to all eight LCGs);
An extended short format to report one BSR (of one LCG);
An extended long format to report several BSRs (up to all 256 LCGs).

NOTE: The Extended versions of the BSR formats can only be used by IAB nodes.

Uplink buffer status reports are transmitted using MAC signalling. When a BSR is triggered (e.g. when new data arrives in the transmission buffers of the UE), a Scheduling Request (SR) can be transmitted by the UE (e.g. when no resources are available to transmit the BSR).

For IAB, the Pre-emptive BSR can be configured on the backhaul links. The Pre-emptive BSR is sent based on expected data rather than buffered data, as described in clause 4.7.3.3.

For WAB, the Pre-emptive BSR can be configured on the backhaul links. The Pre-emptive BSR may be triggered by a WAB-gNB based on predicted messages to be sent over NGAP or Xn.

Power headroom reports (PHR) are needed to provide support for power-aware packet scheduling. In NR, three types of reporting are supported: a first one for PUSCH transmission, a second one for PUSCH and PUCCH transmission in an LTE Cell Group in EN-DC (see TS 37.340 [21]) and a third one for SRS transmission on SCells configured with SRS only. In case of CA, when no transmission takes place on an activated SCell, a reference power is used to provide a virtual report. To allow network to detect UL power reduction, the PHR reports may also contain Power Management Maximum Power Reduction (P-MPR, see TS 38.101-2 [35]) information that UE uses to ensure UE compliance with the Maximum Permissible Exposure (MPE) exposure regulation for FR2, which is set for limiting RF exposure on human body. Power headroom reports are transmitted using MAC signalling.

### ---------------38.331 Release 18 V18.2.0---------------

While the disclosure has been shown and described with reference to certain examples, it will be understood by those skilled in the art that various changes in form and detail may be made therein without departing from the scope of the disclosure, as defined by the appended claims.

Certain examples of the disclosure provide one or more techniques as disclosed in the specification examples above. The skilled person will appreciate that any of these techniques may be applied in combination with any of the techniques described above and illustrated in the Figures.

In a first example, there is provided a method of a relay node in a communication network, the method comprising: identifying a condition at the relay node; and in response to identifying the condition, transmitting, to a second network node over a backhaul connection, scheduling assistance information; wherein the condition is at least one of: determining, based on information received from a first network node, that data will have to be transmitted over the backhaul connection, and determining, based on identifying a procedure being performed or to be performed by at least one of the first network node, the relay node or the second network node, that data will have to be transmitted by the relay node over the backhaul connection.

In a second example, there is provided the method of the first example, wherein the relay node is a wireless access backhaul (WAB) node.

In a third example, there is provided the method of the first or second example, wherein the information indicating data to be transmitted over the backhaul connection comprises a BSR.

In a fourth example, there is provided the method of any one of the first to third examples, wherein determining, based on information received from a first network node, that data will have to be transmitted over the backhaul connection comprises: receiving information indicating data to be transmitted to the relay node; and determining if the indicated data comprises data to be transmitted over the backhaul connection.

In a fifth example, there is provided the method of the fourth example, wherein determining if the indicated data comprises data to be transmitted over the backhaul connection comprises: identifying if the indicated data comprises user plane data; and determining that the indicated data is data to be transmitted over the backhaul connection if the data is user plane data.

In a sixth example, there is provided the method of the fourth or fifth examples, wherein transmitting the scheduling assistance information comprises: including, in the scheduling assistance information, information related to data to be transmitted over the backhaul connection from among the data to be transmitted to the relay node; and excluding, from the scheduling assistance information, information related to data not to be transmitted over the backhaul connection from among the data to be transmitted to the relay node.

In a seventh example, there is provided the method of any one of the first to sixth examples, wherein the scheduling assistance information comprises a pre-emptive buffer status report (BSR).

In an eighth example, there is provided the method of any one of the first to seventh examples, wherein identifying a procedure being performed or to be performed by at least one of the first network node, the relay node or the second network node comprises identifying at least one of: an RRC setup procedure, an RRC resume procedure, another RRC procedure, and a handover procedure.

In a ninth example, there is provided the method of any one of the first to eighth examples, wherein the scheduling assistance information includes information indicating the identified condition.

In a tenth example, there is provided the method of any one of the first to ninth examples, wherein the transmitting of the scheduling assistance information is configured by the second network node.

In an eleventh example, there is provided the method of any one of the first to tenth examples, wherein the data that will have to be transmitted over the backhaul connection is at least one of: UE CONTEXT RELEASE REQUEST, RAN CP RELOCATION INDICATION, RETRIEVE UE INFORMATION, HANDOVER REQUIRED, HANDOVER NOTIFICATION, HANDOVER CANCEL, UPLINK RAN STATUS TRANSFER, UPLINK RAN EARLY STATUS TRANSFER, UPLINK NAS TRANSPORT, HANDOVER REQUEST ACKNOWLEDGE, SN STATUS TRANSFER, HANDOVER CANCEL, RETRIEVE UE CONTEXT REQUEST/RESPONSE, RAN PAGING, XN-U ADDRESS INDICATION, UE CONTEXT RELEASE, HANDOVER SUCCESS, CONDITIONAL HANDOVER CANCEL, EARLY STATUS TRANSFER.

In a twelfth example, there is provided a method of a wireless access backhaul (WAB) node in a communication network, the method comprising: identifying a condition at the WAB node; and in response to identifying the condition, transmitting, to a backhaul gNodeB (gNB) over a backhaul connection, a pre-emptive buffer status report (BSR); wherein the condition is at least one of: identifying that an uplink (UL) grant is provided to user equipment (UE) in response to a BSR that indicates a logical channel not associated with a system resource block (SRB), identifying that a BSR is received from a UE and the BSR indicates a logical channels not associated with an SRB, identifying a trigger from the radio resource control (RRC) layer, and identifying that a message will be sent over at least one of the NGAP and Xn interfaces.

In a thirteenth example, there is provided the method of the twelfth example, wherein the WAB node is a WAB mobile termination (WAB-MT) node.

In a fourteenth example, there is provided the method of the twelfth or thirteenth examples, wherein the transmitting of the scheduling assistance information is configured over the backhaul connection.

In a fifteenth example, there is provided a first network entity (e.g. a relay node or WAB node) configured to operate according to a method of any of the first to fourteenth examples.

In a sixteenth example, there is provided a second network entity (e.g. a relay node or WAB node) configured to cooperate with a first network entity of the fifteenth example according to a method of any one of the first to fourteenth examples.

In a seventeenth example, there is provided a network or wireless communication system comprising a first network entity according to the fifteenth example and a second network entity according to the sixteenth example.

In an eighteenth example, there is provided a computer program comprising instructions which, when the program is executed by a computer or processor, cause the computer or processor to carry out a method according to any one of the first to fourteenth examples.

In a nineteenth example, there is provided a computer or processor-readable data carrier having stored thereon a computer program according to the eighteenth example.

In a twentieth example, there is provided a method of a wireless access backhaul (WAB) node in a communication network, the method comprising: identifying a condition at the WAB node; and in response to identifying the condition, transmitting, to a second network node (e.g. gNB) over a backhaul connection, scheduling assistance information; wherein the condition is at least one of: determining, based on a buffer status report (BSR) received from a first network node (e.g. a UE), that data will have to be transmitted over the backhaul connection, and determining, based on identifying a procedure being performed, to be performed, or having been performed by at least one of the first network node, the WAB node or the second network node, that data will have to be transmitted by the WAB node over the backhaul connection.

In a twenty-first example, there is provided the method of the twentieth example, wherein determining, based on a BSR received from a first network node, that data will have to be transmitted over the backhaul connection comprises: receiving the BSR indicating data to be transmitted to the WAB node; and determining if the indicated data comprises data to be transmitted over the backhaul connection.

In a twenty-second example, there is provided the method of the twenty-first example, further comprising: identifying the condition if the indicated data comprises data to be transmitted over the backhaul connection; and not identifying the condition if the indicated data comprises data that is not to be transmitted over the backhaul connection.

In a twenty-third example, there is provided the method of the twenty-first or twenty-second example, wherein determining if the indicated data comprises data to be transmitted over the backhaul connection comprises determining based on at least one of: data type, data destination, logical channel, logical channel group, radio bearer, radio bearer type, uplink resources.

In a twenty-fourth example, there is provided the method of the twenty-third example, wherein determining if the indicated data comprises data to be transmitted over the backhaul connection based on data type comprises: identifying if the indicated data comprises user plane data; and determining that the indicated data is data to be transmitted over the backhaul connection if the data (e.g., the date type) is at least one of: user plane data, or control plane data that is terminated in the core network of the first network node.

In a twenty-fifth example, there is provided the method of the twenty-third or twenty-fourth example, wherein determining if the indicated data comprises data to be transmitted over the backhaul connection based on data type comprises: determining that the indicated data is not data to be transmitted over the backhaul connection if the data (e.g., the date type) is not at least one of: user plane data, or control plane data that is terminated in the core network of the first network node.

In a twenty-sixth example, there is provided the method of any of the twenty-first to twenty-fifth examples, wherein transmitting the scheduling assistance information comprises: including, in the scheduling assistance information, information related to data to be transmitted over the backhaul connection from among the data to be transmitted to the WAB node; and excluding, from the scheduling assistance information, information related to data not to be transmitted over the backhaul connection from among the data to be transmitted to the WAB node.

In a twenty-seventh example, there is provided the method of any of the twentieth to twenty-sixth examples, wherein the scheduling assistance information comprises a pre-emptive BSR.

In a twenty-eighth example, there is provided the method of any of the twentieth to twenty-seventh examples, wherein identifying a procedure being performed or to be performed by at least one of the first network node, the WAB node or the second network node comprises identifying at least one of: an RRC setup procedure, an RRC resume procedure, another RRC procedure, and a handover procedure.

In a twenty-ninth example, there is provided the method of any of the twentieth to twenty-eighth examples, wherein the scheduling assistance information includes at least one of: information indicating the identified condition; information indicating that a new UE has attached or requested access; information indicating that a new relay node has attached or requested access; a number of hops needed to reach a base station.

In a thirtieth example, there is provided the method of any of the twentieth to twenty-ninth examples, wherein the transmitting of the scheduling assistance information is configured by the second network node.

In a thirty-first example, there is provided the method of any of the twentieth to thirtieth examples, wherein the data that will have to be transmitted over the backhaul connection is at least one of: UE CONTEXT RELEASE REQUEST, RAN CP, RELOCATION INDICATION, RETRIEVE UE INFORMATION, HANDOVER REQUIRED, HANDOVER NOTIFICATION, HANDOVER CANCEL, UPLINK RAN STATUS TRANSFER, UPLINK RAN EARLY STATUS TRANSFER, UPLINK NAS TRANSPORT, HANDOVER REQUEST ACKNOWLEDGE, SN STATUS TRANSFER, HANDOVER CANCEL, RETRIEVE UE CONTEXT REQUEST/RESPONSE, RAN PAGING, XN-U ADDRESS INDICATION, UE CONTEXT RELEASE, HANDOVER SUCCESS, CONDITIONAL HANDOVER CANCEL, EARLY STATUS TRANSFER.

In a thirty-second example, there is provided the method of any of the twentieth to thirty-first examples, wherein identifying the condition at the WAB node comprises identifying the condition at the WAB node in at least one of: the MAC layer, or the RRC layer.

In a thirty-third example, there is provided the method of any of the twentieth to thirty-second examples, wherein the scheduling assistance information indicates a buffer size, and wherein the method further comprises: determining the buffer size based on at least one of: an expected buffer size, a network-configured offset, or a predetermined offset.

In a thirty-fourth example, there is provided the method of any of the twentieth to thirty-third examples, further comprising: receiving, from the first network node, data; and forwarding, to the second network node, at least part of the data over the backhaul connection.

In a thirty-fifth example, there is provided the method of the thirty-fourth example, wherein the forwarded data is the data determined as having to be transmitted over the backhaul connection based on the BSR.

In a thirty-sixth example, there is provided the method of any of the twentieth to thirty-fifth examples, further comprising indicating, to the second network node, that the WAB node supports transmitting the scheduling assistance information.

In a thirty-seventh example, there is provided the method of any of the twentieth to thirty-sixth examples, wherein the WAB node has a first backhaul connection to the second network entity, and a second backhaul connection to a third network entity (e.g. gNB), and wherein the method further comprises identifying the condition based on a whether the data will have to be transmitted over the first backhaul connection or the second backhaul connection.

In a thirty-eighth example, there is provided the method of any of the twentieth to thirty-seventh examples, wherein identifying a procedure being performed, to be performed, or having been performed by at least one of the first network node, the WAB node or the second network node comprises identifying messages expected to be transmitted by the WAB node.

In a thirty-ninth example, there is provided a method of a wireless access backhaul (WAB) node in a communication network, the method comprising: identifying a condition at the WAB node; and in response to identifying the condition, transmitting, to a backhaul gNodeB (gNB) over a backhaul connection, a pre-emptive buffer status report (BSR); wherein the condition is at least one of: identifying that an uplink (UL) grant is provided to a user equipment (UE) in response to a BSR that indicates a logical channel not associated with a system resource block (SRB), identifying that a BSR is received from a UE and the BSR indicates a logical channel(s) not associated with an SRB, identifying a trigger from the radio resource control (RRC) layer, and identifying that a message will be sent over at least one of the NGAP and Xn interfaces.

In a fortieth example, there is provided the method of the thirty-ninth example, wherein the WAB node is a WAB mobile termination (WAB-MT) node.

In a forty-first example, there is provided the method of the thirty-ninth or fortieth example, wherein the transmitting of the scheduling assistance information is configured over the backhaul connection.

In a forty-second example, there is provided a first network entity (e.g. a WAB node) configured to operate according to a method of any of the twentieth to forty-first examples.

In a forty-third example, there is provided a second network entity (e.g. a gNB) configured to cooperate with a first network entity of the forty-second example according to a method of any one of the twentieth to forty-first examples.

In a forty-fourth example, there is provided a network or wireless communication system comprising a first network entity according to the forty-second example and a second network entity according to the forty-third example.

In a forty-fifth example, there is provided a computer program comprising instructions which, when the program is executed by a computer or processor, cause the computer or processor to carry out a method according to any one of the twentieth to forty-first examples.

In a forty-sixth example, there is provided a computer or processor-readable data carrier having stored thereon a computer program according to the forty-fifth example.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

### Abbreviations/Definitions

In the present disclosure, the following abbreviations and definitions may be used.

| | | | |
|---|---|---|---|
| 3GPP | 3^{rd} Generation Partnership | 5G | 5th Generation |
| | Project | | |
| 5GC | 5G Core | AMF | Access and Mobility |
| | | | Management Function |
| BH | Backhaul | BSR | Buffer Status Report |
| CP | Control Plane | CU | Central Unit |
| DU | Distributed Unit | eLCID | extended LCID |
| F1 | interface between DU and | gNB | 5G base station |
| | CU | | |
| IAB | Integrated Access and | ID | Identity/Identification |
| | Backhaul | | |
| IP | Internet Protocol | IE | Information Element |
| LCG | Logical Channel Group | LCH | Logical Channel |
| LCID | Logical Channel ID | LTE | Long Term Evolution |
| MAC | Medium Access Control | MT | Mobile Termination |
| NAS | Non-Access Stratum | NG | Interface between 5G |
| | | | RAN and Core |
| NGAP | Next Generation | NR | New Radio |
| | Application Protocol | | |
| PDU | Packet Data Unit | Qos | Quality of Service |
| RAN | Radio Access Network | | |
| RAN2 | Radio layer 2 and Radio | | |
| | layer 3 Working Group | | |
| Rel | Release | RLC | Radio Link Control |
| RRC | Radio Resource Control | SCH | Shared Channel |
| TR | Technical Report | TS | Technical Specification |
| UE | User Equipment | UL | UpLink |
| UP | User Plane | UPF | User Plane Function |
| Uu | Air interface between | | |
| | terminal and base | | |
| | station/access point | | |
| Xn | Interface between 2 base | | |
| | stations | | |

What is claimed is:

1. A method of a wireless access backhaul (WAB) node in a wireless communication system, the method comprising:
identifying a condition at the WAB node; and
in response to identifying the condition, transmitting, to a second network node over a backhaul connection, scheduling assistance information;
wherein the condition is at least one of:
determining, based on a buffer status report (BSR) received from a first network node, that data will have to be transmitted over the backhaul connection,
determining, based on identifying a procedure being performed, to be performed, or having been performed by at least one of the first network node, the WAB node or the second network node, that data will have to be transmitted by the WAB node over the backhaul connection,
identifying that an uplink (UL) grant is provided to a user equipment (UE) in response to a BSR that indicates a logical channel not associated with a system resource block (SRB),
identifying that a BSR is received from a UE and the BSR indicates a logical channel not associated with an SRB,
identifying a trigger from the radio resource control (RRC) layer, or
identifying that a message will be sent over at least one of the NGAP or Xn interfaces.

2. The method of claim 1, wherein determining, based on the BSR received from a first network node, that data will have to be transmitted over the backhaul connection comprises:
receiving the BSR indicating data to be transmitted to the WAB node; and
determining whether the indicated data comprises data to be transmitted over the backhaul connection.

3. The method of claim 2, further comprising:
identifying the condition in case that the indicated data comprises data to be transmitted over the backhaul connection.

4. The method of claim 2, wherein whether the indicated data comprises data to be transmitted over the backhaul connection is determined based on at least one of:
data type;
data destination;
logical channel;
logical channel group;
radio bearer;
radio bearer type; or
uplink resources.

5. The method of claim 4, wherein determining whether the indicated data comprises data to be transmitted over the backhaul connection based on the data type comprises:
identifying whether the indicated data comprises user plane data; and
determining that the indicated data is data to be transmitted over the backhaul connection in case that the data type is at least one of:
user plane data, or
control plane data that is terminated in the core network of the first network node.

6. The method of claim 4, wherein determining whether the indicated data comprises data to be transmitted over the backhaul connection based on the data type comprises:
determining that the indicated data is not data to be transmitted over the backhaul connection in case that the data type is not at least one of:
user plane data, or
control plane data that is terminated in the core network of the first network node.

7. The method of claim 2, wherein transmitting the scheduling assistance information comprises:
including, in the scheduling assistance information, information related to data to be transmitted over the backhaul connection from among the data to be transmitted to the WAB node; and
excluding, from the scheduling assistance information, information related to data not to be transmitted over the backhaul connection from among the data to be transmitted to the WAB node.

8. The method of claim 1, wherein the scheduling assistance information comprises a pre-emptive BSR.

9. The method of claim 1, wherein identifying a procedure being performed or to be performed by at least one of the first network node, the WAB node or the second network node comprises identifying at least one of:
an RRC setup procedure;
an RRC resume procedure;
another RRC procedure; or
a handover procedure.

10. The method of claim 1, wherein the scheduling assistance information includes at least one of:
information indicating the identified condition;
information indicating that a new UE has attached or requested access;
information indicating that a new relay node has attached or requested access; or
a number of hops needed to reach a base station.

11. The method of claim 1, wherein the transmitting of the scheduling assistance information is configured by the second network node.

12. The method of claim 1, wherein the data that will have to be transmitted over the backhaul connection is at least one of:
UE CONTEXT RELEASE REQUEST;
RAN CP RELOCATION INDICATION;
RETRIEVE UE INFORMATION;
HANDOVER REQUIRED;
HANDOVER NOTIFICATION;
HANDOVER CANCEL;
UPLINK RAN STATUS TRANSFER;
UPLINK RAN EARLY STATUS TRANSFER;
UPLINK NAS TRANSPORT;
HANDOVER REQUEST ACKNOWLEDGE;
SN STATUS TRANSFER;
HANDOVER CANCEL;
RETRIEVE UE CONTEXT REQUEST/RESPONSE;
RAN PAGING;
XN-U ADDRESS INDICATION;
UE CONTEXT RELEASE;
HANDOVER SUCCESS;
CONDITIONAL HANDOVER CANCEL; or
EARLY STATUS TRANSFER.

13. The method of claim 1, wherein identifying the condition at the WAB node comprises identifying the condition at the WAB node in at least one of:
a Medium Access Control (MAC) layer; or
a Radio Resource Control (RRC) layer.

14. The method of claim 1,
wherein the scheduling assistance information indicates a buffer size, and
wherein the method further comprises:
determining the buffer size based on at least one of:
an expected buffer size,
a network-configured offset, or
a predetermined offset.

15. The method of claim 1, further comprising:
receiving, from the first network node, data; and
forwarding, to the second network node, at least part of the received data over the backhaul connection.

16. The method of claim 15, wherein the forwarded data is the data determined as having to be transmitted over the backhaul connection based on the BSR.

17. The method of claim 1, further comprising indicating, to the second network node, that the WAB node supports transmitting the scheduling assistance information.

18. The method of claim 1,
wherein the WAB node has a first backhaul connection to the second network entity, and a second backhaul connection to a third network entity, and
wherein the method further comprises identifying the condition based on a whether the data will have to be transmitted over the first backhaul connection or the second backhaul connection.

19. The method of claim 1, wherein identifying a procedure being performed, to be performed, or having been performed by at least one of the first network node, the WAB node or the second network node comprises identifying messages expected to be transmitted by the WAB node.

20. A wireless access backhaul (WAB) node in a wireless communication system, the WAB node comprising:
a transceiver; and
at least one processor coupled to the transceiver,
wherein the at least one processor is configured to:
identify a condition at the WAB node, and
in response to the identifying of the condition, transmit, to a second network node over a backhaul connection, scheduling assistance information, wherein the condition is at least one of:
determining, based on a buffer status report (BSR) received from a first network node, that data will have to be transmitted over the backhaul connection,
determining, based on identifying a procedure being performed, to be performed, or having been performed by at least one of the first network node, the WAB node or the second network node, that data will have to be transmitted by the WAB node over the backhaul connection,
identifying that an uplink (UL) grant is provided to a user equipment (UE) in response to a BSR that indicates a logical channel not associated with a system resource block (SRB),
identifying that a BSR is received from a UE and the BSR indicates a logical channel not associated with an SRB,
identifying a trigger from the radio resource control (RRC) layer, or
identifying that a message will be sent over at least one of the NGAP or Xn interfaces.
